(19) United States
(12) Patent Application Publication
(10) Pub. No.: US 2006/0074919 A1
(43) Pub. Date: Apr. 6, 2006

(54) Searching industrial component data, building industry networks, and generating and tracking design opportunities

(76) Inventors: Sunil K. Grover, San Jose, CA (US); Rajeev Ranjan, Noida (IN)

Correspondence Address: FENWICK & WEST LLP, SILICON VALLEY CENTER, 801 CALIFORNIA STREET, MOUNTAIN VIEW, CA, 94041, US

(21) Appl. No.: 11/200,993

(22) Filed: Aug. 9, 2005

Related U.S. Application Data
(60) Provisional application No. 60/601,280, filed on Aug. 12, 2004.

(51) Int. Cl. G06F 17/30

(52) U.S. Cl. 707/10

(57) ABSTRACT

Processes (and system) are disclosed for aggregation of product part number, associated description, and product parameter for a plurality of products from plurality of web sites. One embodiment includes identifying a product manufacturer web site and executing crawler to extract information from databases exposed on the manufacturer web site. Also disclosed is processes (and system) for tracking sales opportunities through a sales cycle. One embodiment includes receiving input relating to a sales opportunity from a first buyer having a first role, the input comprising requirements for the sales opportunity including predefined checkpoints and transmitting to the first buyer a request for updated information relating to the sales opportunity, the updated information corresponding to the predefined checkpoints.

### CROSS REFERENCE TO RELATED APPLICATIONS

This application claims priority under 35 USC § 119(e) to U.S. Provisional Patent Application No. 60/601,280, filed Aug. 12, 2004, and titled “System and Process for Searching Industrial Component Data, Generating Design Wins and Tracking Global Sales Resulting From the Design Win”, the contents of which are herein incorporated by reference.

### BACKGROUND OF THE INVENTION

1. Field of the Invention

The present invention generally relates to the field of data management, and more specifically, to data manipulation and analysis.

2. Description of the Related Art

The electronics industry is a very large, highly fragmented, global marketplace. Presently, there are estimated to be over 100,000 companies making electronic equipment and systems. Electronic equipment and systems use components that are classified as electronic, electromechanical or semiconductor components. These components are manufactured by over tens of thousands of component manufacturers worldwide. These components are most often referred to by part numbers assigned by the component manufacturer (a.k.a. supplier). Currently, the total number of component part numbers worldwide for the above mentioned component types is estimated to be over 25 million. Further, there are hundreds of parameters associated to each of these components.

Tracking such data in this hierarchical model can be quite complex. The complexity is further exasperated by the fact that the parameters associated with each component often change on a scheduled basis every 3 to 5 months. In some contexts, such as pricing, the complexity is further increased by the fact that pricing and availability of each of these components can change at any time.

In addition to the above, the sales process for these components also is highly complex. For example, the sales process can occur over multiple stages and in different countries. Moreover, it may require simultaneous support from people in many companies. Presently, there are several thousands of third party companies such as manufacturer's representatives or distributors that support the suppliers' sales cycle from design to delivery.

Given the very large number of constantly changing components available, it is very difficult for an engineer designing a new electronic system, for example, a laptop, a cell phone, or gaming system, to easily locate the components needed to complete a board design. Current mechanisms used by engineers include reading through paper based product catalogs, phone calls, one-on-one personal meetings, as well as searching on the Internet.

Presently, one option available to engineers is to use of one of several component data base companies that have manually entered the data into a master database. However, access to these databases is expensive and the data is often old, unreliable, and not comprehensive due to the infrequency of regular updates.

In addition, another problem with present systems is that they keep product data in different formats for suppliers and distributors. Specifically, manufacturers' representatives and distributors provide system engineers with support in the design process and subsequently design-in or sell the components they represent. The component data available to them from the suppliers is in different formats. It is not easy and often not possible for suppliers to keep these third party companies, collectively the “sales-channel” up-to-date with the latest product information with current mechanisms. As a result, the product data available at the rep or distributor location may not be the latest or the same as that available at the suppliers' location or through other sources.

Another problem with present solutions is that different unconnected software platforms have been adopted by companies to automate processes. Leading suppliers have invested in expensive customized software automation systems to manage their sales channel. Apart from being expensive and very cumbersome to use, there are several other problems. First is that of data entry. These systems require the sales person to work through the tedious interfaces and manually enter all the data. This leads to sales people not using such systems regularly, which in-turn, defeats the purpose of these systems. Other companies have invested heavily in training or assigned data entry operators for entering data into the system. This limits the amount of information that is entered to be the minimal amount and does not provide a collaborative exchange of information.

Moreover, as the opportunity progresses in the sales cycle, the data needs to be updated, but it cannot, since it is impossible to get the data from the different users within the customer and funnel their data in through the data entry operators. These systems do not allow the customers to input and update the data. Finally, every supplier uses a different system with their own unique user interfaces and requiring separate logins. Even if these systems have the ability to allow customers to enter the data, the customers are required to register into multiple systems that don't interact with each other. Further, the channel users supporting the suppliers' sales cycle are required to learn multiple systems and have their data saved in multiple databases.

Still another problem with current offerings is that generation of new electronic component sales driven through web sites has largely been unsuccessful. Currently available software systems are too expensive to customize to meet the sophisticated functionality requirements for navigating the complex cycle of selling electronic components. Existing e-commerce systems are too simplistic to facilitate the requirements from engineers and buyers in the electronics industry. Moreover, the taxonomy required to present electronic components is very specific to the industry. This situation has made it rather inefficient for engineers and buyers to use the Internet related mechanism to purchase new electronic components. This in-turn has limited the number of new sales generated through the web.

In addition to the above noted problem with present web sites, another problem is that inquires generated from such sources are difficult to track and do not allow for efficient follow up. Most system design engineers go to the Internet first to search for components. This leads to online inquiries sent to suppliers via email. It takes a lot of time for the supplier and its sales channel to manage these inquiries using the current systems available. As a result these opportunities are either ignored or lost. This results in support being provided only to the potentially high volume opportunities that can justify the costs involved in supporting them, leaving the system design engineers working on smaller opportunities or with smaller companies largely unattended.

Still another problem with current solutions is difficulty in tracking efforts of individuals or companies in a sales cycle. Multiple companies across the world are involved in the sale of a component from design stage to volume production on a single opportunity. It is an enormous problem to be able to effectively track the effort and contribution of each company or individual and reward them appropriately as the opportunity moves from one country to another.

The cycle of manufacturing a new system is long and involves system board design, prototyping, price negotiations, scheduling and finally manufacturing purchase. As the opportunity moves from one stage to another it can take one of the many forms like Request for Information, Request for Quote, Sample Order, online small quantity e-commerce order or volume/repeat purchase order. As the opportunity matures from one stage to another, often it moves from one country to another. For example, when designing and manufacturing a cell phone, the sample may be ordered by a user in a company located in San Jose Calif., the Request for Quote may come from a user in an independent second company based in Finland and the final manufacturing purchase order may come from another company in China. However, they all may be related to the same opportunity.

The supplier's sales channel of manufacturer reps and distributors is compensated on a percentage of total sales resulting from the opportunities they serviced. For fairness, as well as to keep the sales channel motivated, suppliers need an easy way to track these opportunities. Currently, there is no software system that connects all companies in the electronics industry and can be used to track the sales cycle.

Thus, from the above, there is a need for a system and process that allows for searching industrial component data, building industry networks, generating design wins and tracking global sales resulting from the design win.

### SUMMARY OF THE INVENTION

The present invention includes a system and a method that addresses the problems discussed above. The disclosed embodiments include a system (and a method) for search, network access and tracking in contexts such as global sales resulting from a design win.

In one embodiment involving search, a web-based data aggregation methodology extracts data from searchable databases exposed on various websites. An indexing schema aggregates this data together with data accumulated through different sources (e.g., the various web sites). A relevancy based, search result ranking algorithm displays more relevant search results higher and speeds the search result.

In one embodiment involving network access, a mechanism creates a web-based global industry network that allows all users from all companies from the industry to be instantly registered on a central database with pre-configured workflows within the companies and across companies. These registrations are configured to allow instant customization to create private networks that include certain companies and users. In addition, the mechanism allows for selection and instant customization of workflow and functions that are available to various users in companies selected for the private network.

In one embodiment involving tracking, a web-based configuration allows for tracking an opportunity as it progresses through the sales cycle. Further, the configuration also tracks through multiple stages across many companies and countries.

The benefits of disclosed embodiments include easy access for system engineers to current, comprehensive and reliable product information and support. It also enables these engineers to find component information they are looking for from the supplier's website and save it for future reference. This in turn accelerates the pace of innovation design and product development.

Another benefit of the disclosed embodiments is instant access to relevant information that enables members of a sales team to provide better support without spending additional time and effort. By bringing engineers to search and find product information, the system generates leads and product related inquiries for suppliers and their sales channel. It also enables the suppliers to automatically assign a global team to support the inquiries, convert them into design wins and subsequently track the global sales resulting from a single point of design. By providing a tracking mechanism it ensures that different organizations or subsidiaries of a company and third party manufacturers' representatives and distributors supporting an opportunity are recognized for their efforts and fairly compensated.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1a illustrates one embodiment of a system and a network configuration in accordance with the present invention.

FIG. 1b illustrates one embodiment of a computing system configuration in accordance with the present invention.

FIG. 2 illustrates one embodiment of a block diagram representation of componenst of a system in accordance with the present invention.

FIG. 3 illustrates one embodiment of buy side and sell side high level aspects in accordance with the present invention.

FIG. 4 illustrates one embodiment of buy side and sell side company types in accordance with the present invention.

FIG. 5 illustrates one embodiment of sell side information flow through a system in accordance with the present invention.

FIG. 6 illustrates one embodiment of buy side information flow through a system in accordance with the present invention.

FIG. 7 illustrates one embodiment of a configuration for a vertical search engine in accordance with the present invention.

FIG. 8 illustrates one embodiment of data indexing schema in accordance with the present invention.

FIG. 9 illustrates one embodiment of a configuration for a crawler to extract data in accordance with the present invention.

FIG. 10 illustrates one embodiment for data aggregation through batch files in accordance with the present invention.

FIG. 11 illustrates one embodiment for processing search results in accordance with the present invention.

FIG. 12 illustrates one embodiment for inputting data for a search in accordance with the present invention.

FIG. 13 illustrates one embodiment for optimizing keyword ranking in accordance with the present invention.

FIG. 14 illustrates one embodiment for private engine search processing in accordance with the present invention.

FIG. 15 illustrates one embodiment for setting up a private network for a supplier in accordance with the present invention.

FIG. 16 illustrates one embodiment for inviting and signing-up a manufacturing representative in accordance with the present invention.

FIG. 17 illustrates one embodiment of including a manufacturing representative in an opportunity in accordance with the present invention.

FIG. 18 illustrates one embodiment for inviting and signing-up a distributor in accordance with the present invention.

FIG. 19 illustrates one embodiment of including a distributor in an opportunity in accordance with the present invention.

FIG. 20 illustrates one embodiment for inviting additional members into a network in accordance with the present invention.

FIG. 21 illustrates one embodiment of accessing a private network in accordance with the present invention.

FIG. 22 illustrates one embodiment of accessing a public network in accordance with the present invention.

FIG. 23 illustrates one embodiment of inviting additional members into a network in accordance with the present invention.

FIG. 24 illustrates one embodiment of creating and registering an opportunity in accordance with the present invention.

FIGS. 25 through 27 illustrate one embodiment for assigning a tracking identification (ID) at a request for quotation (RFQ) in accordance with the present invention.

FIGS. 28 and 29 illustrate one embodiment of assigning split commissions at a purchase order in accordance with the present invention.

FIG. 30 illustrates one embodiment for opportunity tracking in accordance with the present invention.

### DETAILED DESCRIPTION OF THE PREFERRED EMBODIMENTS

The Figures (“FIG.”) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Architectural Overview

Embodiments of the present invention include a data processing system for accumulating product information and availability data at one server location that can be easily searched and information received. For ease of discussion, the product information will be described in the context of industrial information, and more particularly, electronic components of the electronics industry. However, those skilled in the art will appreciate that the principles described herein may be applicable to other industries and/or products.

Additionally, embodiments of the present invention also include a mechanism by which all the users from all the companies from the global electronics industry are allowed to use a hosted public network which has a single instance of the database allowing a single login password specific for each user to access. It gives the users the ability to create private networks as a subset of the public network. This enables users from multiple companies in the industry to use the same system and interface for all their partners. It is noted that a public network is accessible to anyone visiting a web site available or accessible to the public (e.g., www.beganto.com). The rules, functionality access, invitations and company roles are managed by a web site administrator. The users, companies, office locations and functionalities available in a private network are a subset of the public network. In this the rules, invitations and company roles etc. are managed by a private network administrator who has been given that role by the web site administrator. If any user joins the private network, the user automatically joins the public network. Access to information available on the private network is governed by the private network administrator. Same user may be invited into and therefore be able to join multiple private networks.

Further, embodiments of the present invention also include a system configured to track opportunities (e.g., marketing and/or sales opportunities) as they progress through various stages including search, design win, prototyping, volume production or similar such distinct milestones that an opportunity can mature through. The combinations of the private and public networks to include all companies involved in the electronics industry enables the central system to track all opportunities.

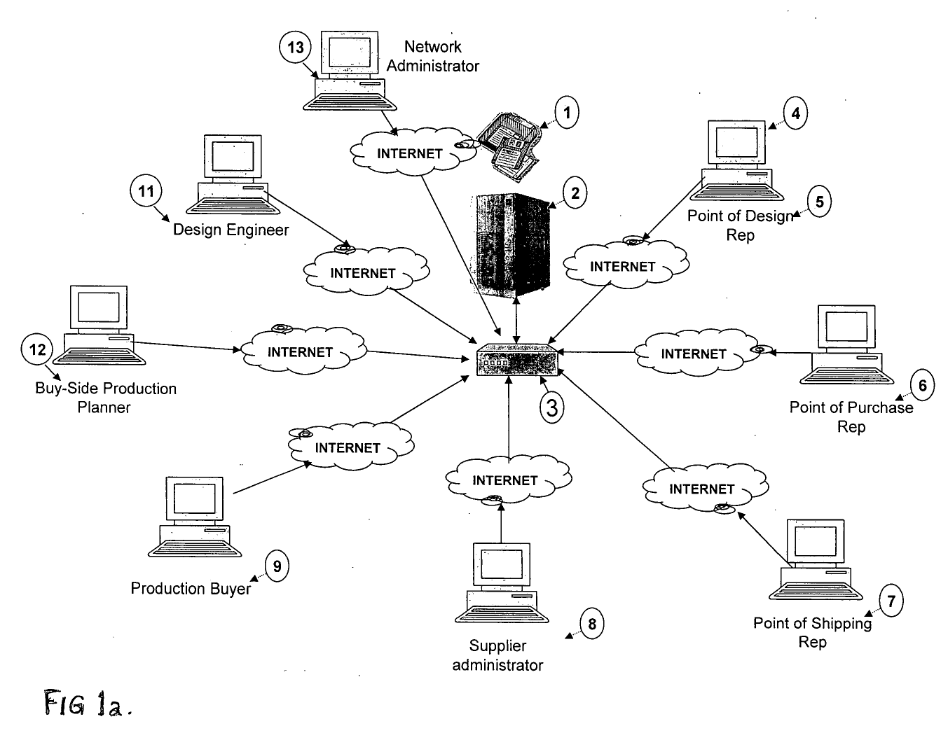

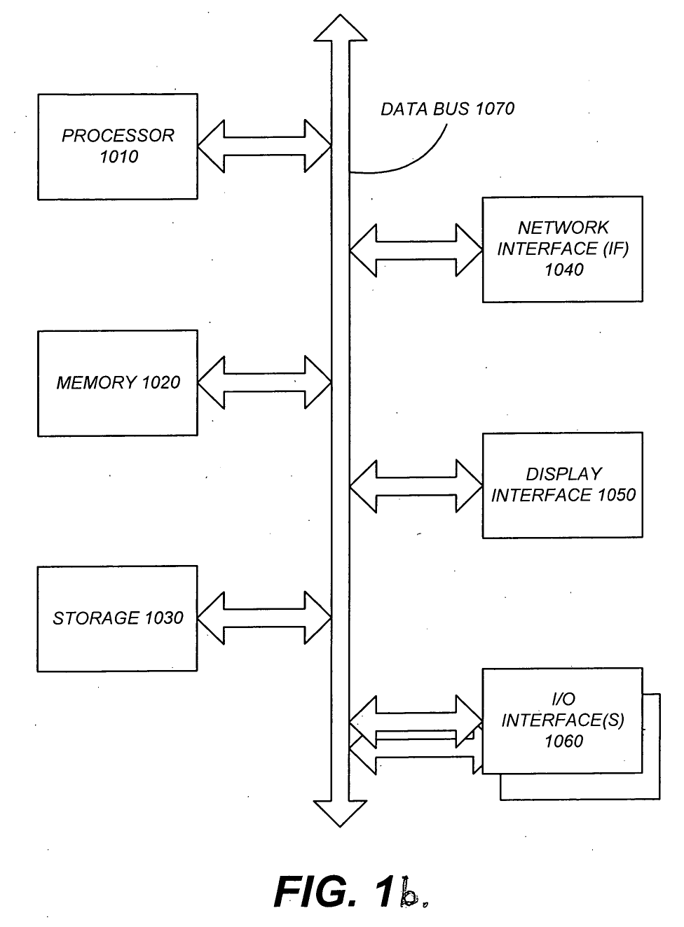

FIG. 1a illustrates one embodiment of a system and network configuration in accordance with the present invention. In particular, FIG. 1a illustrates that the software 1 resides on a server 2 that can be accessed on a hosted network through a router 3. The various participants, on the buy side, in the design to manufacture cycle for a new system and on the sell side, supporting the sales cycle for a component that gets designed into a new system, are outlined in the figure. These can be multiple users from different types of companies with uniquely different roles within that company. Also included in the figure is the network administrator who can monitor the performance and control various aspects of the whole system 13.

The point of design representative (or rep) 5 engages in several activities to enable the design engineer 11 to design-in the components. This is accomplished through personal sales visits, telemarketing, tradeshow participation, phone calls and hand carrying a sample to establish contact with the engineer. Subsequently, the point of design representative 5 provides product selection assistance, product suggestion and product marketing. In addition, the point of design representative 5 may provide free samples, paper catalog based and other offline marketing of products.

In one embodiment, the point of design representative 5 can track and follow-up on all the activities with engineers by accessing this software through a computer 4 connected to the server via the Internet. Furthermore, many inquiries coming directly from the engineer to the website of the component manufacturer can be automatically forwarded to the rep based on pre-defined permissions and rules.

Once the new system design works, it goes into prototype testing and subsequently is approved to go into mass production, the design engineer 11 forwards the bill of material (BOM) containing information on all the components to be used and quantities required to the production planner 10. The design engineer 11 can either forward the BOM or trigger the system to invite in the production planner, e.g., through a web site or electronic mail configured system.

The production planner 10 may be referred to as project manager, manufacturing manager or program manager. Similarly, on the side providing support on component sales, the point of design representative 5 invites the point of purchase representative 6 into the opportunity. The overall process can be controlled and managed by the supplier administrator 8. The point of purchase representative 6 is engaged in several activities including forecasting, arranging the price and delivery schedule, getting purchase order (PO), entering the order into the company's enterprise resource planning (ERP) system, preparing invoice and all related activities to ensure that the components are ready for shipment freight on board (FOB) manufacturer's warehouse.

The point of shipping representative (or final manufacturing location representative) 7 is responsible for the activities to get the components shipped from the component manufacturer's warehouse to the point where the cash for the components has been received. This includes taking care of orders received by the production buyer 9 taking care of any logistics, return merchandize authorization (RMA) or quality issues, and payment collections.

In one embodiment, design engineers 11 can take care of multiple system designs that include hundreds of suppliers and forward these designs to the production planner 10 who can generate and track the pricing on the components for the bill of materials from hundreds of suppliers and their appropriate representatives 5, 6, 7. This data can be archived and subsequently retrieved and modified at a later date for a new project as needed by the system engineers.

The production buyers 9 can use this system to place inquiries, requests for quotes (RFQ) and purchase orders (PO) from the supplier's representatives of all the components on the bill of material (BOM) and track deliveries online. Similarly, on the sell-side, the supplier administrator can manage and re-route inquiries, request for quotes and orders coming to them and have visibility on the activity status on any inquiry at any time. The representatives 5, 6, 7 can manage the opportunities they have across multiple suppliers that they represent. Each of these user types has accounts that are classified as admin accounts and user accounts. Admin accounts will have ability to configure the features available to various users. They will also have the ability to invite other users and companies into the account.

FIG. 1b illustrates one embodiment of a computer system, of which one or more may be used in accordance with the present invention, for executing processes as described herein. It is noted that one example configuration of the computer system includes a processor 1010, a memory 1020, a storage 1030, a network interface (IF) 1040, a display interface 1050, and one or more other input/output (IO or I/O) interfaces 1060. The processor 1010, the memory 1020, the storage 1030, the network interface 1040, the display interface 1050, and the input/output interfaces 1060 are communicatively coupled through a data bus 1070.

The processor 1010 is a conventional processor, for example, a complex instruction set computing processor (e.g., an Intel® Pentium® processor or AMD Athlon™ processor), a reduced instruction set computing processor (e.g., an IBM® PowerPC processor or Sun® SPARC® processor), or a specialized or highly optimized processor (e.g., IBM/Toshiba/Sony Cell Processor). The processor 1010 is configured to run a conventional operating system, e.g., Microsoft® Windows™ or Windows CE, Linux, Lindows, Apple® OS X, IBM MVS or VM, Sun Microsystems® Solaris™, or Palm Source® Palm OS. The processor 1010 with operating system is configured to execute instructions corresponding to the steps of processes disclosed herein. The processes disclosed herein may be structured as instructions using conventional computer programming tools, e.g., programming languages, compilers, and the like.

The memory 1020 is a conventional memory, for example, a dynamic random access memory (DRAM), a static random access memory (SRAM), or a synchronous DRAM (SDRAM). The memory 1020 is configured to store (e.g., temporarily during operation of the processor) information, for example, instructions, data, etc. The storage 1030 is a conventional storage medium, for example, a magnetic storage (e.g., magnetic hard drive), an optical storage (e.g., a CD or DVD based drive and medium), or solid state storage (e.g., a flash memory or electrically erasable programmable read only memory). The storage 1030 is configured to store information, for example, instructions, data, etc.

The network interface 1040 is a conventional network interface for connecting with a wired (e.g., Ethernet) or wireless (e.g., WiFi or other IEEE 802.11, WiMax or other IEEE 802.16, or Bluetooth) network through a communication protocol. Examples of networks that the network interface 1040 could communicatively couple include wide area networks such as an Internet or local area networks such an Intranet. An example of a communication protocol is TCP/IP. The display processor 1050 is a conventional display processor configured to drive data, for example, still and motion text, images and graphics, to a visual display. The input/output interfaces 1060 are conventional input/output interfaces for use with the computing system, for example, an audio interface (e.g., microphone and/or a speaker), or I/O ports such as a universal serial bus (USB) interface or an IEEE 1394 (e.g., Apple® FireWire) interface.

Components Overview

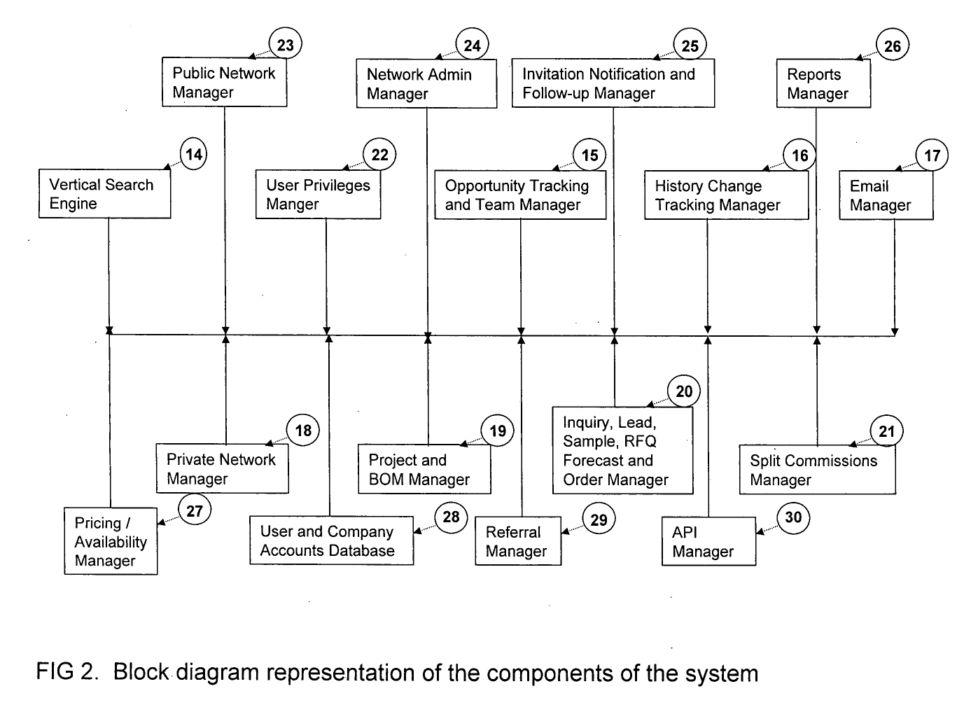

FIG. 2 illustrates one embodiment of a block diagram representation of components of a system in accordance with the present invention. The components include a vertical search engine 14, an opportunity tracking and team manager mechanism 15, a history change tracking manager 16, an electronic mail (e-mail) manager 17, a private network manager 18, a project and BOM manager 19, an inquiry, lead, sample, RFQ, forecast and order manager 20, a split commissions manager 21, a user privileges manager 22, a public network manager 23, a network administration manager 24, an invitation notification and follow up manager 25, a reports manager 26, a pricing and availability manager 27, a user and company accounts database 28, a referral manager 29, and an API manager 30. Each manager may be configured in software having standalone functionality (e.g., a module), but also is configured to communicatively couple one or more other managers (e.g., data exchange and/or message passing).

Referring to some of the components in additional detail, the vertical search engine 14 is configured as a mechanism for aggregating, indexing and searching the vast universe of electronic component data. The pricing and availability manager 27 is configured to tracks the pricing and availability changes to the products accessed through the vertical search engine 14. The pricing and availability of products worldwide can change any minute and enables the system to track these changes. The public network manager 23 manages all users and companies that are registered in the system. It stores and updates the different relationships between various companies that are registered in the public network.

If a user is invited into a private network, and that user joins the private network, he automatically joins the public network (i.e. if a private network administrator adds a user, that user gets added to the public network with predefined roles). For example, the private network manager 18 enables companies to build a private network of companies and invite users who are already participating in the public network and/or to invite users and companies to join into the network. It also manages the permissions and functions available to various companies who have access to the private network.

The user and company accounts database 28 has all login, password, contact and company information of registered users. Different users are allocated different privilege levels by the user privilege manager 22. This also includes the company type that defines the function the company plays in the industry and on the systems network. In the specific case of the embodiment in the electronics industry the various company types have been classified through processes such as those described in, for example, FIG. 4. These companies could be on the buy-side, e.g., 34, 37, or sell-side, e.g., 35, 38.

Buy-side includes companies or users and/or offices within companies involved in the buying of components. Examples of buy-side include engineers, buyers, program managers, and the like from companies illustrated and describe as “buy-side” for example, in FIG. 4. Sell-side includes companies or users and offices within companies involved in the selling of components. Selling of components may occur over a long and complex cycle including design phase, procurement phase and manufacturing phase. Typically, different individuals are involved in these tasks. For example, a distributor is a reseller. So on one part they are on the buy-side, they have buyers who buy components from suppliers and on the other hand they are on the sell side as they have sales staff involved in the selling of components.

With respect to dual buy-side and sell-side roles in a design cycle, one particular type of company or individual of note is contract manufactures. Contract manufacturers offer services such as outsourcing of manufacturing of electronics systems. However, they also offer redesign services to replace components with equivalent cost effective parts. Contract manufacturers often redesign the board and add in components where they might get a sales commission form the supplier. This is their role on the sell side. Contract manufacturers buy from various suppliers to assemble an electronic system board and sell the completed board on a turnkey or time and materials basis to OEMs. Here they are involved in the role of buying the components for manufacturer or being on the buy side.

It is noted that roles in the electronics industry keep changing and the contract manufacturers and distributors perform roles in both the buy side and the sell side. Based on these privileges, users can invite other registered users or register new users and invite them in on an opportunity. These privileges can also include territory and supplier assignments for which the individual users have responsibility.

Referring back to FIG. 2, the project and bill of materials (BOM) manager 19 allows system engineers to manage the part and product information on their BOM. A BOM is a group of components along with the quantity per unit required to build a system or electronic equipment. Often a BOM has part numbers internal to the system maker and these are mapped to the alternate equivalent components made available from one or more suppliers. After searching for a component and saving that information in their account, engineers can have easy retrieval for information related to these products. Through the BOM manager, the system engineer or production planner or buyer can initiate inquiries, sample requests, requests for quotes and purchase orders to suppliers. The responses to these can be saved within that BOM.

The inquiry, Lead, RFQ, Quote, Sample, Forecast and Order manager 20 is a set of online workflow management tools available to users to manage the inquiries, leads, RFQ, quotes, forecasts and orders. It allows allocating a team on each opportunity and processing it through the sales cycle including creating inquiries, responding to inquiries, requesting samples and processing samples, creating RFQs and responding with Quotes, creating Purchase Orders based on quote or catalog listing and processing a purchase order into a shipment order. It allows for search within account for data, sending free samples for testing and trial purposes to system engineers who have inquired on a component.

The referral manager 29 keeps track of which company has invited whom to join the network. This can be used to create incentive programs for referring others to join the network. It also manages the subsequent follow-up actions after the initial referral has been sent out. The history change tracking system 16 uses tracking ID that was assigned at the very beginning when the inquiry is created as the index and records the changes to the opportunity as it matures through the cycle. It records what changes are made, when the changes were made and who made these changes. This also includes tracking the system generated, automatic, email notifications like those that may go to design engineers to inquire about the status or updates on the projects they are currently pursuing.

The email manager 17 enables the network to build by facilitating emails between different parties at different stages of the system development process. These are either auto-initiated by the system or initiated by manual intervention of any of the concerned parties. It also records the preferences customized by individual users on when they want to receive emails on what items.

The split commissions manager 21 automatically allocates commission splits based on criteria preset by the supplier to the representatives involved in supporting the opportunity. Supplier Admin has the ability to review edit or modify these splits before they are processed or disclosed to the associated representatives.

The invitation notification and follow-up manager 25 manages the invitations that are sent by the system automatically or are sent through user initiations. It also manages the subsequent follow-up email invitations send to the various users in the public or private network. The network administration manager 24 has access to all functionalities of all users and overall administration of the network.

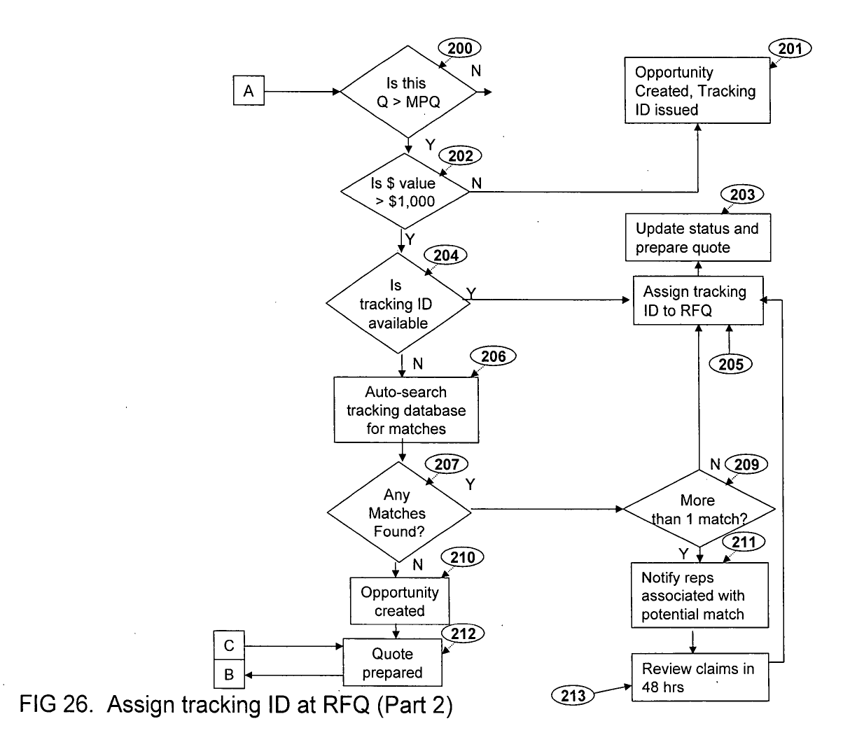

The opportunity tracking and team manager 15 assigns a unique tracking ID to every opportunity in the network (including public and private networks). It also manages which members of which network have access to the opportunity. Further details are described in FIG. 26. Reports Manager 26 captures the data in the network into easy to read and review reports that can be accessed based on certain preferences. API Manager 30 enables the system to exchange data with other software systems outside the network through a pre-defined set of software and data-exchange interfaces based on industry standards like XML, EDI, FTP etc. This allows the back-end CRM, ERP applications to directly connect to the network.

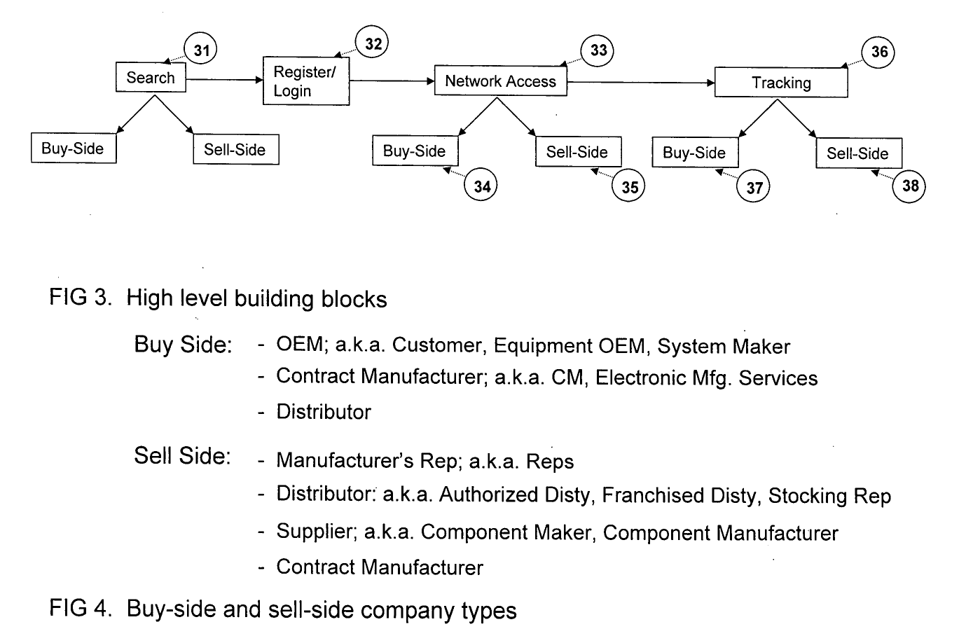

FIG. 3 illustrates one embodiment of buy-side and sell-side high level aspects in accordance with the present invention. This embodiment of the high-level aspects divides a system into three sections. The first section is search 31, which includes registration and login 32. After successful registration and login 32, the next section is network access 33, which controls which company has access to what functionalities and opportunities. The final section is tracking 36 of the opportunities (e.g., buying and selling opportunities) as the opportunity matures through the sales cycle. The system is further configured to allow the system to define roles in which functionality and access is divided under the categories of buy-side, e.g., 34, 37, and sell-side, e.g., 35, 38 at the search 31, network access 33, and tracking stages 36.

FIG. 4 illustrates one embodiment of buy-side and sell-side company types in accordance with the present invention. Specifically, examples of buy-side company types, e.g., 34, 37, include an original equipment manufacturer (OEM), a contract manufacturer, an electronic manufacturing service, a system maker, or a distributor. Examples of sell-side company types, e.g., 35, 38, include a distributor, a manufacturer's rep, a supplier (i.e., a component manufacturer), a contract manufacturer, or a component manufacturer.

Operational Configurations

With respect to operation consideration, in one embodiment of the present invention an indexed data set is exposed on the Internet through a search facility and it brings engineers and buyers to a web site to search for information they are seeking. These actions generate inquiries that are captured and saved as being related to an underlying opportunity. In one embodiment the system builds a global database of opportunities generated through request for information, sample orders, request for quotation, design registrations etc. Subsequently, it enables the supplier to assign a multifunctional global team from different channel companies to service and support the opportunity from design to prototype to planning to volume manufacturing stage.

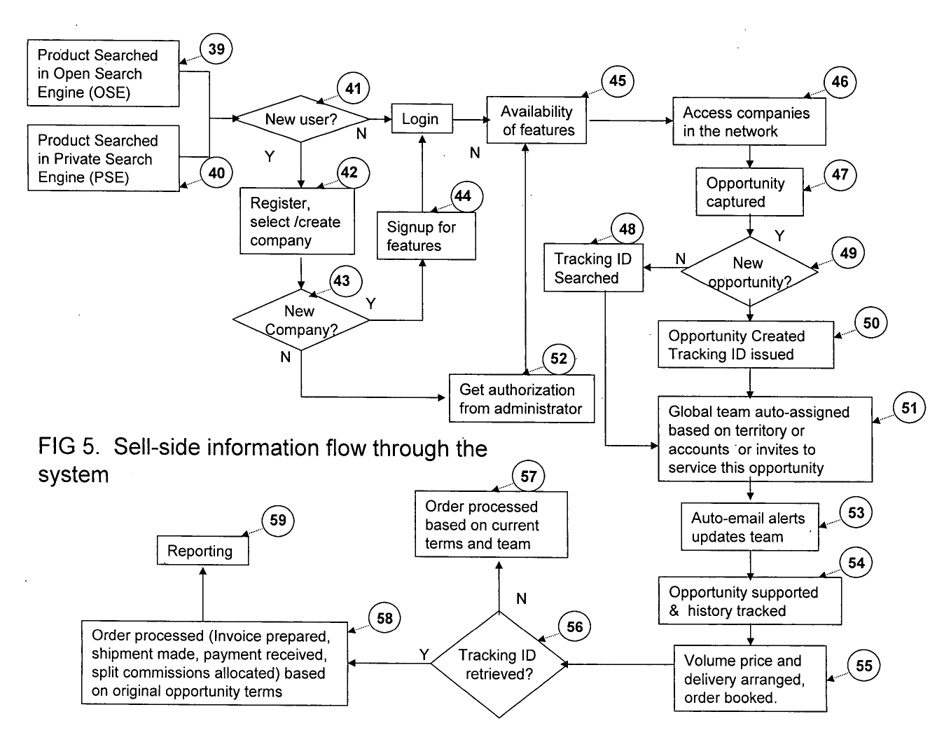

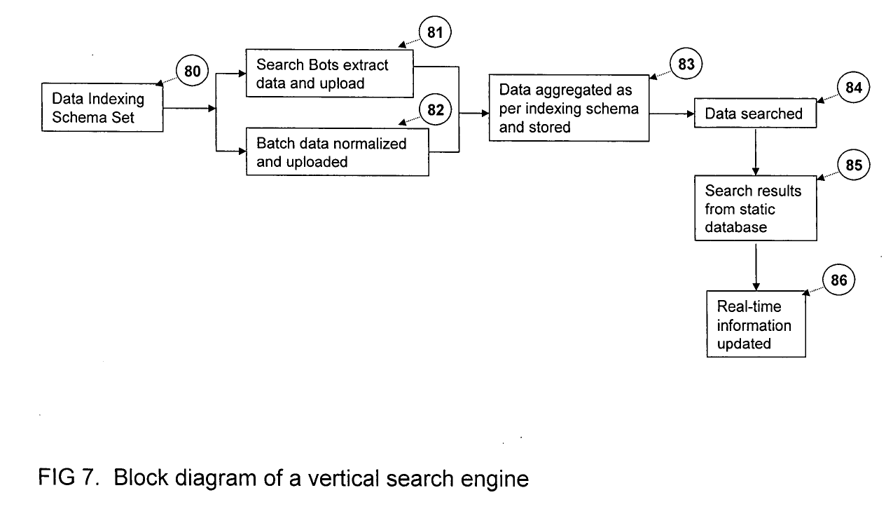

FIG. 5 illustrates one embodiment of sell side information flow through a system in accordance with the present invention. A system engineer (or other personnel) or buyer (or other personnel) searches 40 for products either on the open search engine (OSE) 39 or the private search engine (PSE) on the supplier's website. The data for the search is provided by the supplier administration or automatically collected from the supplier's corporate website by the system using the system's data crawler functionality, which is further described in FIG. 7. Based on the returned search results, if an engineer has an inquiry the system requires the user to register 42 and login. The system also determines 43 if the company is a new company and generates a URL for the private network. In one embodiment, the URL for the private network is a unique URL that may integrate a customer number (e.g., as predefined by the system) within the URL (e.g., as a prepended or appended identifier or as a hash). If the user has administrator status, the user can sign-up 44 and select certain pre-defined features, for example, RFQ management, reporting, RFI-lead management, and privileges for adding new users. Depending on how the user was either invited into or signed up into the system, the user will have access or availability 45 to certain predefined features depending on the company type and access 46 to public and or private networks.

As an example, a user can select one of the following example options to classify the inquiry: (1) technical question on a product type or request for additional information on a part number, (2) request for samples to test a part number, (3) information for purchasing a small volume quantity for prototypes, (4) request on pricing and delivery for higher volumes, (5) online e-commerce transaction, or (6) request for additional information. This enables the opportunity to get captured into the system 47.

The system checks if the inquiry is a new opportunity based on a particular set of rules, for example, as further described with respect to FIG. 26. If the inquiry is a new opportunity, a tracking identification (ID) is issued 50. If the opportunity is a follow-up action on an existing one, the system tries to search 48 and retrieve the tracking ID related to it, for example, as described in detail with respect to FIG. 26.

It is noted that in one embodiment for all new opportunities, the local rep assigned for that component by that component manufacturer is automatically assigned 51. The local rep or the engineer may also invite the local or regional distributor for support. Further, if it is clear that the purchasing and/or manufacturing on this opportunity will happen in a geography different than the one in which the initial inquiry began from or where the design takes place, the representative responsible for that geography for purchasing support and/or shipping support will be automatically invited in. The manufacturer's representative or supplier can invite-in a representative or distributor into the opportunity as needed.

Upon invitation, email messaging sends the additional parties (e.g., manufacturing rep or supplier) an automatic email inviting them into the opportunity. This email can include a link that, when clicked, leads to a page where the user can verify information, enter other details and submit to automatically create an account. Subsequently, the team assigned to the opportunity can access the opportunity details or the history and be alerted on the updates at any time. As needed they can support 54 the opportunity.

As an opportunity progresses, from design/prototype to volume manufacturing the same opportunity can be selected from a “my projects” tab on a buy-side user interface “dashboard” or other visual presentation offering and/or can be searched or auto-retrieved to access the historic information. The price and delivery terms for the volume purchase related to the opportunity are arranged 55 and added on to the opportunity details. Certain suppliers can require their reps to enter a volume forecast at this stage as well. The process determines 56 if the tracking ID is retrieved from predetermined procedures, for example, as outlined in FIG. 26, and the split commissions are allocated 58 to reward the representatives involved in the opportunity for their upfront efforts. When the request for quote (RFQ) converts into an order the commission payouts are due and when the order payments are received, the commission payouts are processed 58, 59.

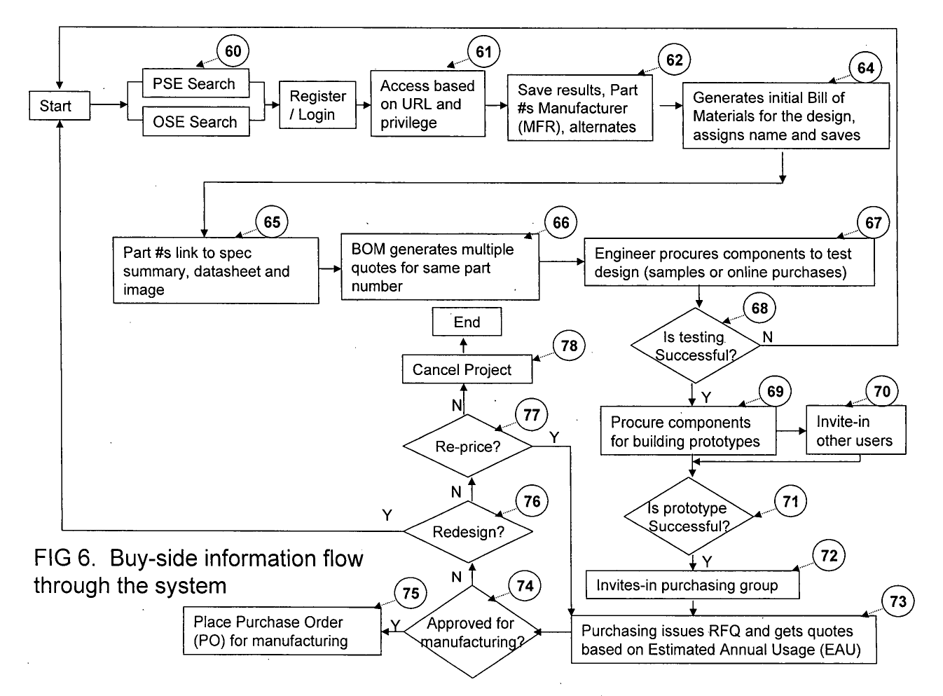

FIG. 6 illustrates one embodiment of buy-side information flow through a system in accordance with the present invention. This embodiment is illustrated through an example in which a user from the buy-side, for example, an engineer, production planner or buyer, at an OEM company uses an embodiment of the disclosed system.

In this example, the engineer uses the system to search 60 and select components. Depending on the URL (e.g., a system generated URL that may be unique for a private network) the engineer is using to access the system, the engineer has limited access to the data to search 60 from or the features he can use to process the opportunity after login 61. The system captures data related to the search result including the description of the selected components and the bill of material (BOM) 62. These can then be forwarded by the system to another user, the purchasing manager, within the same company or within the company's private network, to search for price and availability on these products. If the electronic system designed goes into mass production, the purchasing manager uses this data from the current system in its preferred embodiment to send out RFQ (request for quotes) the components for volume manufacturing of the electronic system.

The system engineer has the ability to save different components under sets assigned 64 as bill of material. As the system engineer saves these components, the system engineer also can save 65 information related to these components, for example, datasheets, alternates, internal part number, contact information of local manufacturer's representative, sales representative, or the like, and link all such information to that part number. The system engineer can save multiple bills of material under different names for future reference. The system engineer also is provided the link to request for additional information or price quote on the components through a click of a button 66. This creates an inquiry and is given a tracking ID in the system. This inquiry is auto-routed to the local manufacturer representative for that supplier.

If based on the answers to their inquiry the system engineer decides to procure 67 that component for testing, the system engineer can request for sample. The local manufacturer's rep or supplier administrator can approve that sample request at which point it gets routed to the supplier sampling program to ship the sample to the engineer. The system allows the manufacturer rep to update the shipment tracking number. The system notifies the engineer of the shipment tracking number and follows up in determined time, e.g., 7 days, to ensure that samples were able to reach the engineer as needed. After a predetermined time period, e.g., 30 days, and again after another predetermined time period, e.g., 90 days, the system sends an email notification to the system engineer to check if the sample testing was successfully completed and if the sample was designed in or opted out 68. This interval can be configured by the supplier administrator.

If the components tested by the system engineer did not serve the purpose for the design that the system engineer was working on, the system engineer can search for other component that may serve the purpose by redesigning and going back to starting point of BOM generation 66. If the component was tested successfully the system engineer can procure 69 a component by either forwarding the bill of material to the purchasing manager or placing an online order for the prototype order quantity or request for a quote and place an order for that order quantity.

The process continues with determining 71 whether a prototype is successful. This may be evaluated through when the bill of material that the engineer is working on is completely tested. Alternatively, it may be any time before that engineer can create a related project and forward, e.g. via invitation 72, that opportunity to the purchasing manager to source volume purchase requirements and custom pricing for the components in that bill of material. The purchasing manager issues 73 request for quotes (RFQ) for the volume purchase requirements. These requests for quotes can be issued out for each component in the bill of material or the approved alternates for each component.

The contact information of the authorized distributors, the manufacturers' representatives and of those components in the same location as the place where the system will be manufactured, can get retrieved from the user and company accounts database 28 of the system. The representatives or distributors receiving the request for quote can inform the purchasing manager of the pricing and lead time through the system. The purchasing manager can input the data into the BOM receive the quote or response data automatically in the BOM from the manufacturer representatives or distributor. Based on the pricing received on the components the purchasing manager can decide on which quote to select and place 75 the purchase order for volume manufacturing. Purchasing manager also can request 77 for re-pricing the components should the initially quoted price not be acceptable or subsequently cancel 78 it.

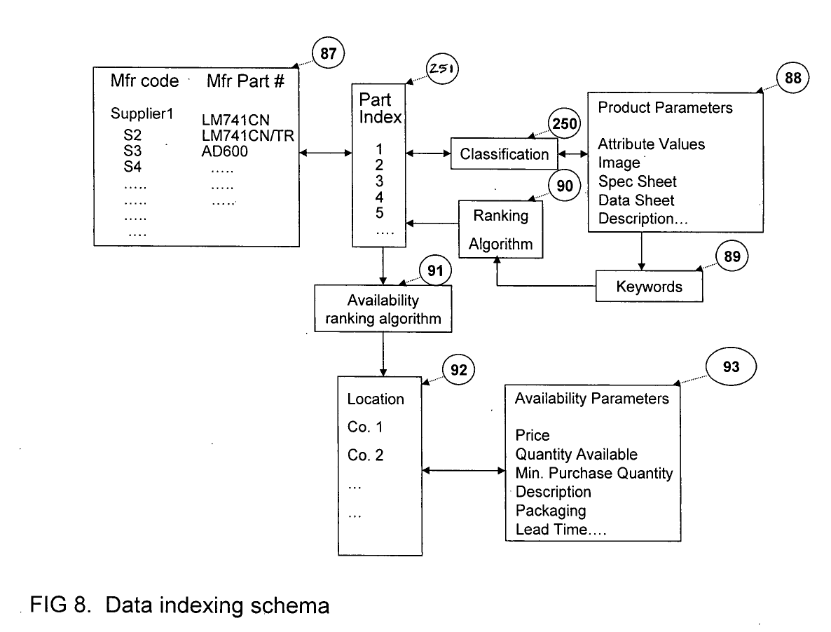

FIG. 7 illustrates one embodiment of a configuration for a vertical search engine, e.g., 14, in accordance with the present invention. A first step includes setting a data schema, for example, by identifying 80 a data indexing schema set. In one embodiment the data schema is set to index a database with respect to a combination of manufacturer name and manufacturer part number. It is noted that the search engine can be configured to index differently for different industries for which the search engine is deployed. It is noted that one embodiment of a taxonomy is described in FIG. 8 with respect to product parameters 88 and classifications 250.

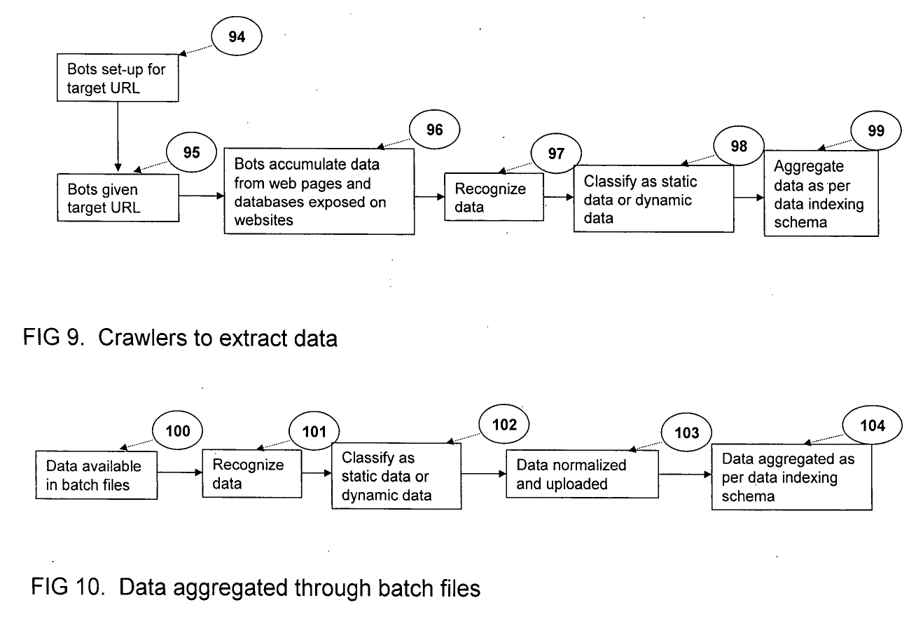

One or more properties related to the component can be assigned, for example, as illustrated in FIG. 8. Search bots go to various websites to extract 81 information from the web pages and databases accessible through the web pages. In one embodiment, data also can be added to the basic index schema by normalizing the data and adding it through batch file uploads 82. As the data is uploaded into the relational database, it is placed based on the indexing schema and stored 83. The data associated could be in the form of static data or dynamic data. These are stored separately in the data indexing schema, for example, as illustrated in FIG. 9, which illustrates details of one embodiment of a data indexing schema.

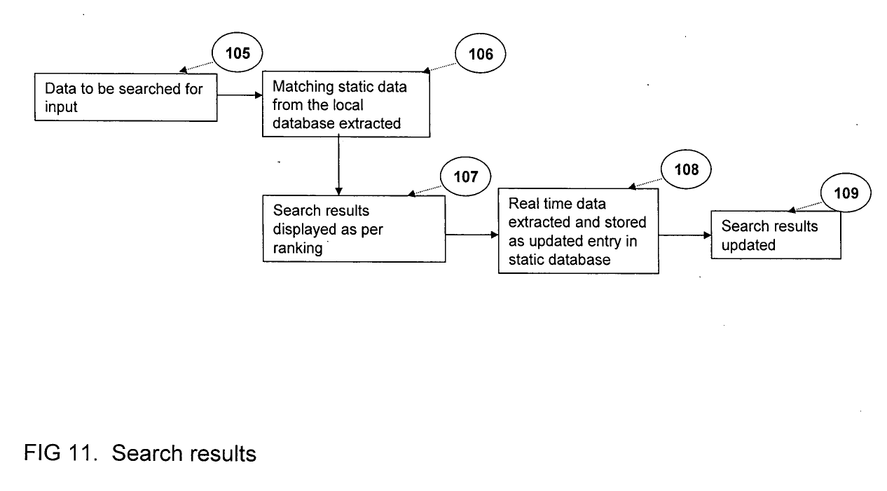

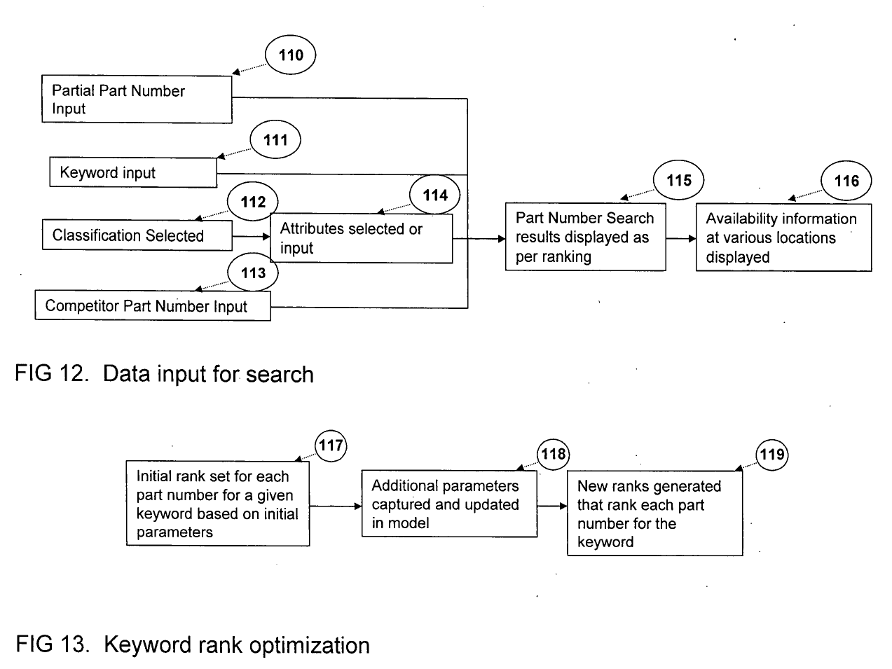

In addition, different portions of the data can be searched 84, for example, as illustrated in FIG. 12. The search results are generated 85 and displayed, for example, from a static database as illustrated in FIG. 11. Subsequently real time information is extracted from the appropriate websites using the real-time bots and the information is updated 86 in the search results displayed.

As noted previously, FIG. 8 illustrates one embodiment of data indexing schema in accordance with the present invention. A part index 251 is generated from a unique combination of the manufacturer code representing a manufacturer name and an alpha numeric character representing the component often referred to as a part number 87.

This index 251 is then placed within a classification schema 250 developed based on a detailed understanding of the various components that exist within an industry, e.g., the electronics industry. This classification also may be referred to as the taxonomy of products in that industry. In addition, this classification can be refined as more information and knowledge about the industry is developed and as the industry and suppliers evolve. The refinement process can be manual, e.g., by reviewing the data and further acting on it, or automated, e.g., contextual processing of the data. As one example of refinement, each classification category has a set of attributes associated to it and each part number with that category is assigned specific values or codes for these attributes 88. Each part number also has the ability to be associated to an image, portable document format (pdf), description and keywords 89. The keywords are associated through a ranking algorithm 90 to the part index. When keywords are searched in the product search tool, for example, as illustrated in FIG. 11, the results displayed in an order determined using this ranking algorithm.

In one embodiment, data associated to the part index is extracted from sources such as websites or from batch files, for example, as reference with respect to FIG. 7. These sources are stored in a database 92 (e.g., which may be relational, heirachical, or flat file). Some of these locations also may be associated with dynamic data 93. If data searched for as illustrated in FIG. 12 is for the part number, order in which the search results are displayed is controlled by the availability ranking algorithm and the source of the data 91, 92. In one embodiment, static data saved in product parameters 88 is displayed first and the dynamic data saved from the last time this data was uploaded is displayed and subsequently, the dynamic crawlers extract information from the sources where the information was collected for in real-time and display the results.

FIGS. 9 and 10 illustrate how the data is aggregated within the system in accordance with the present invention. FIG. 9 illustrates one embodiment of a configuration for a crawler to extract data in accordance with the present invention. In particular, the system is configured so that bots are set-up 94 for accessing a target URL and then given 95 the target URL to proceed with accessing the web site associated with the URL. The bots accumulate 96 data from the web pages (e.g., HTML pages) as well as any databases that are exposed on the web sites. The system continues with conducting a search on the database and captures the resulting data displayed.

The search on the database exposed on the web page referred to above is a “starts with” search in which system searches results displayed are those that start with the letter with three letters entered and the crawler does multiple searches to try the “starts with” search results with all possible alpha-numeric combinations of the three characters as input. From the search results generated, the data is captured in the form of flat files 96. As system recognizes 97 the data, the data is classified 98 as either static data or dynamic data. For example, in one embodiment the system determines if there are matches between data captured and the part index 251 and the taxonomy. When a match found, the data is recognized. In addition, it is noted with respect to availability parameters that dynamic parameters that can change at any time while static parameters either never change or change at regular predefined intervals. Once the data is classified, the system can aggregate 99 the data in a database system as per a predefined indexing schema, for example, as described with respect to FIG. 8.

FIG. 10 illustrates one embodiment for data aggregation through batch files in accordance with the present invention. In this embodiment, data may be received 100 by the system in the form of batch files from suppliers or distributors. A one time process recognizes (or identifies) 101 predetermined parameters in the data and classifies 102 the data as static or dynamic. In particular, parameters are matched against the taxonomy. Some of the parameters in the taxonomy are marked as dynamic parameters and others are marked as static. The data is then normalized and uploaded 103 to a database system for data aggregation and indexing 104 per a predefined schema, for example, as described with respect to FIG. 8.

FIG. 11 illustrates one embodiment for processing search results in accordance with the present invention. In particular, search data, described further with respect to FIG. 12, is input 105. By way of example, FIG. 12 illustrates one embodiment for inputting data for a search in accordance with the present invention. A user can input a manufacturer's partial part number 110, a keyword 111, or a competitor's part number or competitor name 113 and search for results. In addition, a user can also select a classification type 112 from a drop down list of predetermined classifications upon which the various choices of attributes 114 within that classification are displayed. User can then select or input the attributes to search on and the search engine will search through the data in the system and display the search results as per the ranking 115. The static parametric data is displayed at the same time as the dynamic availability data. If the search is conducted on the open search engine, the search results will display results for all manufacturers and from all locations 116.

Referring back to FIG. 11, the search data is matched 106 with static data extracted from the local database 106. The search results are displayed 107 according the search result schema that, one embodiment, is based on predetermined ranking criteria. For example, search results for part number are displayed based on the ranking where the result obtained from the site of highest ranking is displayed first and the so on. The search results for a keyword search are ranked at two levels. First there is a ranking co-relating the keyword searched for to the part number index. Then the part number index is mapped to various locations from where the part number was obtained.

The search results displays first the part number with the highest ranking and the location with the highest ranking for that part number. Then it displays the location with the next highest ranking for that part number and subsequently the various part numbers in decreasing order of ranking. The data results are displayed in two sets. First the data available in the systems database is displayed. Subsequently the bots go to the website location where the information was received from and bring back current information, real-time, and update the results displayed 108. Subsequently, the system stores the data obtained from the real-time bots into the database as the latest version of available information 109. This information is displayed in the first result the next time a search is done that calls for the same search result.

FIG. 13 illustrates one example embodiment for optimizing keyword ranking in accordance with the present invention. If the keyword is associated with the part number when the description and keywords are indexed as per a defined methodology, for example, as described in FIG. 8, then each corresponding part number is given a relative rank 117 from 0-10 for that keyword. When the keyword is searched for, the part number with the highest relative rank is displayed and then the part number with the next highest relative is displayed and so on. Multiple part numbers, their description, links to PDF and specifications can be displayed in a single page result and the rank determines which one shows up on top and which one next.

Several parameters (P) can be taken in as the input values to determine the rank. The rank in the current embodiment of the system is represented as a weighted average of the various parameters.

$$Rj = \frac{{\sum }_{i} {w}_{i} {p}_{i}}{{\sum }_{j = 1}^{j = n} {( {\sum }_{i} {w}_{i} {p}_{i} )}_{j}} \times 10$$

Rj=Rank of the part number (j) for the given keyword;
Wi=Weight given to the parameter Pi for determining the rank;
Pi=Numeric value of the parameter for determining the rank;
n=Total number of part numbers for the given keyword.

In addition, additional parameters can be captured and updated 118 in the model as provided. For example, the ranking parameters can be changed based on the results and percentage click thorough rates obtained. In another example, the effectiveness of the ranking algorithm can be measured to be high in a case where the search leads to a click through on the first one result reinforces the ranking. This can be updated in a batch mode and the parameters used and the relative weight given to determine the relative rank can be improved over time. For example, one of the parameters can be how many times the keyword appears in the PDF file for the part number. Another parameter could be percentage of times that the part number was clicked through on when a given keyword was entered. If entering the keyword resulted in a higher number of clicks through, the ranking of that product will improve. Thus, over time, new ranks may be generated 119 that rank each part number for the keywork.

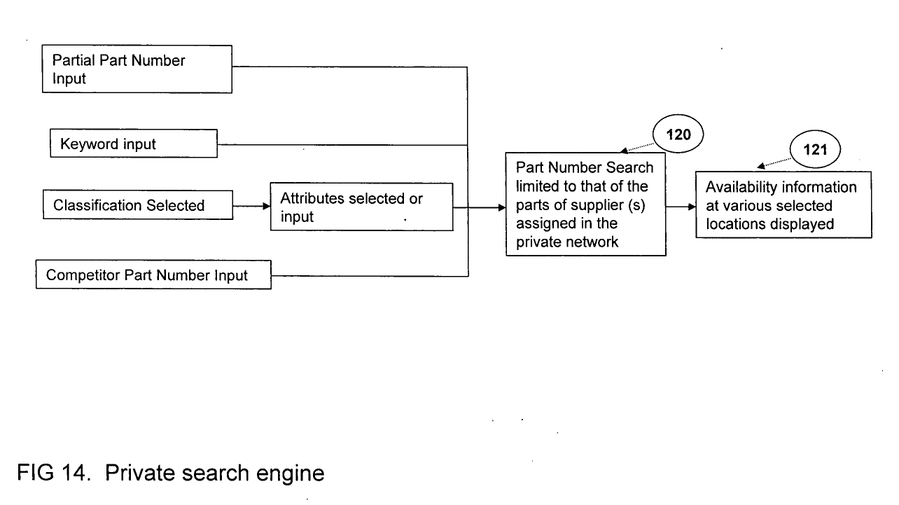

FIG. 14 illustrates one embodiment for private engine search processing in accordance with the present invention. Using the principles set forth herein, for example as described with respect to FIGS. 11 through 13, a search is conducted on a private search engine hosted on the site of a manufacturer can be configured to search and display results only from that one manufacturer 120. In addition, it can be configured to show availability 121 information at various locations (or destinations) selected within a supplier's private network associated with that manufacturer.

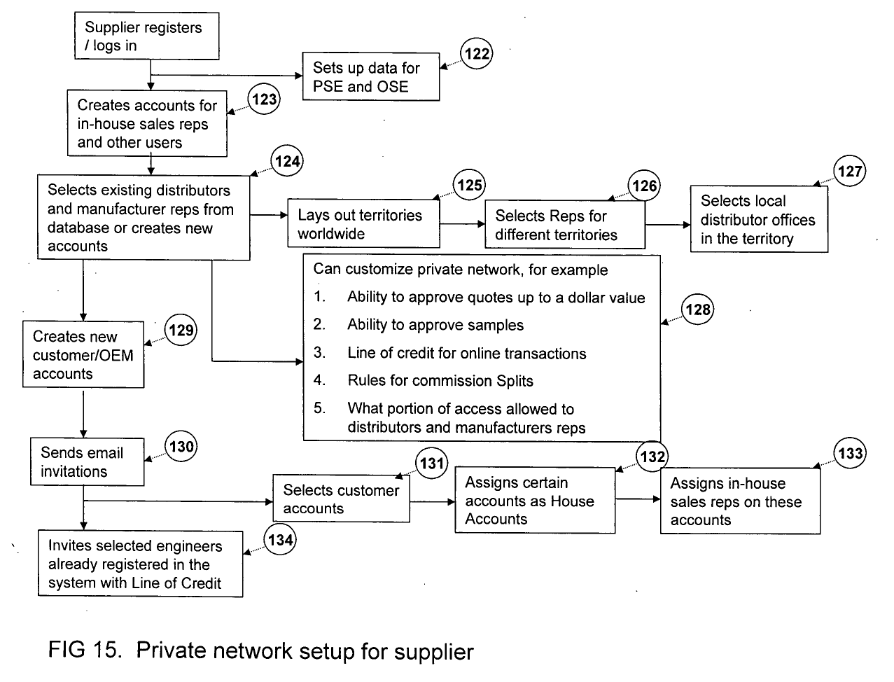

FIG. 15 illustrates one embodiment for setting up a private network for a supplier in accordance with the present invention. As a first step the supplier needs to register/login and enter personal and company contact information, billing and shipping information and other account details. The supplier can do this by accessing a web site addressed through a system supplied unique URL for a private network. The system can be configured so that suppliers joining the public network will be provided a predetermine time period (e.g., 30-day) free trial, but are expected to decide on the set of features that they would like to select.

As a part of the set-up process the supplier administrator enters or provides 122 access to the product information to be advertised in on the public network and the private networks 122, e.g., on the open search engine (OSE) or private search engine (PSE). The supplier can create and enter 123 user account information and data relating their in-house sales reps. Next the process allows for selection 124 of existing distributors and manufacturer reps from database or creates new accounts for them. The process also allows for laying out territories for the distributors or manufacturer reps, for example, it sets-up territory area locations based on either zip codes or cities or states.

Next, the supplier administrator selects 126, 127 sales office territories (or locations) of various manufacturers' representatives and distributors assigned to various territories created by the supplier. These can be setup from the system database of registered accounts or a new account created. The email messenger notifies the account admin for the distributor and manufacturers representatives selected and any new users that might be created by the supplier.

The system is also configured to allow the supplier to set up customer accounts 129 (or other accounts, e.g., OEM accounts), which may include providing user identification (userids). The system uses the e-mail messenger to notify the contacts with the userids to allow those users to select their password for ability to access the account. This email notification 130 can be customized to send the emails out as the accounts are registered or do them all together at one time. Further, supplier can invite 134 engineers registered on the system by providing them some incentive like assigning them a preset limit on the line of credit for their transactions or automatic authorization for free samples.

The system is also configured so that the supplier can select 131 customer accounts to assign 132 them as house accounts. In one embodiment, a house account is a customer (e.g., an OEM or a contract manufacturer) that has been assigned to supplier's user (e.g., employee) for account management. In this case the supplier designated employee manages the relationship and inquiries from the account. In such configurations a third party independent representative may not be responsible for the performance on these accounts. The in-house sales representatives set-up can be assigned 133 to the house accounts in the system. The other new accounts generated can be auto-assigned to the manufacturers reps assigned for the specific territories. These accounts can be reviewed for approval.

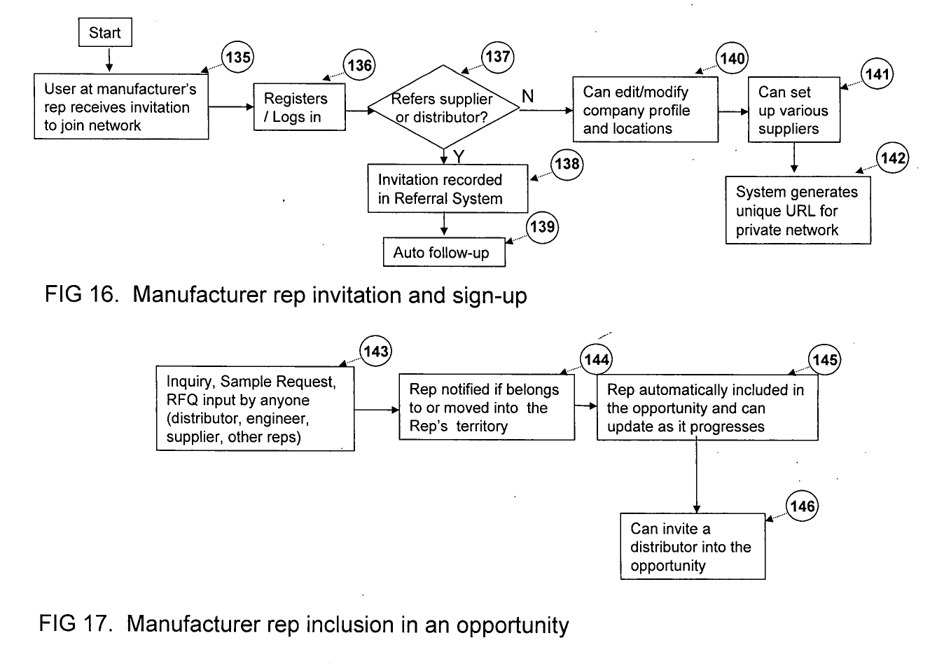

FIG. 16 illustrates one embodiment for inviting and signing-up a manufacturing representative in accordance with the present invention. By way of example, the process may start with a manufacturers' representative receiving 135 an email invitation from the system to join the network. This invitation could be initiated by the supplier inviting the rep into link to the suppliers account on the system or by another registered member on the system.

Once the user registers and logs in 136, manufacturer's representative can enter (or edit and modify) 140 company details and get assigned the appropriate account type and privileges in the system. The manufacturers' representative also has the ability to refer 137 other suppliers or distributors to join their private network or to the system. The system tracks 138 the references initiated by the manufacturer's representative by storing it in a referral database system. The referral database system also can be configured for auto-follow up 139.

The system also can be configured to allow the manufacturer's representative to select the various suppliers that the representative represents and invite them into his private network 141. The system then creates 142 a unique URL that becomes the entry point into the representative's private network.

FIG. 17 illustrates one embodiment of including a manufacturing representative in an opportunity in accordance with the present invention. The process starts and an inquiry or an engineering sample request 143 is entered by the distributor or engineer in the manufacturer representative's territory. The system is also configured to notify 144 the representative if the opportunity represented by the inquiry or sample request belongs to that representative's territory or has moved into that representative's territory. The process can also be configured so that the original message can be altered by the email messenger to go directly to the representative once it has been determined that the opportunity associated with the inquiry or sample request corresponds with the manufacturer representative's area.

In one embodiment, the system is configured automatically to include 145 a manufacturer representative in an opportunity when a new inquiry is received for which the manufacturer representative is responsible. Moreover, the system is configured so that the manufacturer representative can update or automatically can be updated (e.g., present status or change in status) as the opportunity progresses. This update can occur through a user interface associated with the system.

In addition, the manufacturer representative can invite 146 a distributor into an opportunity so that a distributor can also track the opportunity. Privileges for the manufacturer representative on the opportunity are controlled by the supplier for the opportunity if the opportunity came in from the supplier's private network or by rules set-up by the network administrator if the opportunity came in from the public network.

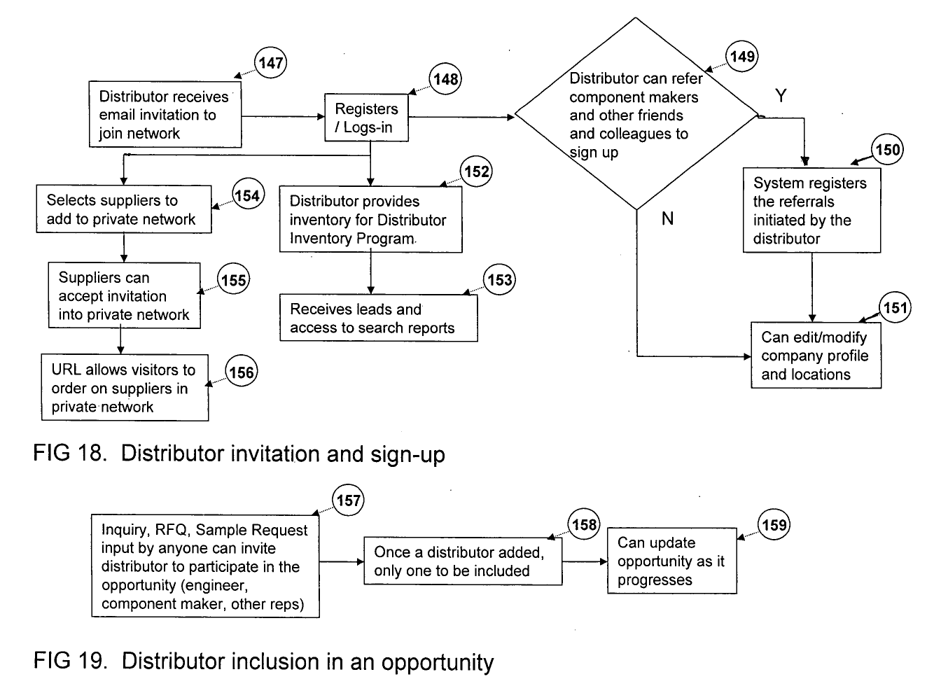

FIG. 18 illustrates one embodiment for inviting and signing-up a distributor in accordance with the present invention. In particular, a flow is shown for a component distributor authorized to distribute the components in their territory by the suppliers. Once the user within a distributor account receives 147 an email invitation into the system or is invited into the system through other equivalent mechanisms, the distributor can log in 148 and verify the company profile information. In addition, the distributor also can refer 154 other suppliers and invite them join their private network (e.g., close business confidants, friends, colleagues, etc.).

The suppliers can accept 155 invitations into the distributor's private network and the system creates 156 a unique URL for access into this private network. The system tracks the referrals initiated by the user 150 and can edit/modify the company profile, office locations, suppliers represented by the local offices and primary sales person for the local office representing the distributor 151.

In addition, the system also is configured to allow a distributor to upload a comma separated variable data file containing information on inventory availability 152 to advertise the information the open search engine and/or private search engine depending on the privileges assigned to the distributor. Based on the inventory available and as initiated by the system engineer or purchasing manager, the distributor can get inquiries, online orders, or request for quotes (or other leads or access (e.g., to search reports)) for the components advertised 153. Distributor can respond with a quote and if the quote is subsequently approved by the purchasing manager receive a purchase order and delivery data for that quote.

FIG. 19 illustrates one embodiment of including a distributor in an opportunity in accordance with the present invention. A user at a system maker or manufacturers representative can invite 157 a distributor into an opportunity. In this case, the distributor gets an email from systems email messenger with a link provided to the specific URL to access within the system to get directly into the opportunity information. In some embodiments, the system can be configured to allow limits 158 that limits the number of entities into an opportunity, for example, only one distributor can be invited into an opportunity. Once distributor is added to the opportunity, the assigned user from the distributor can update 159 notes related to that opportunity as it progresses.

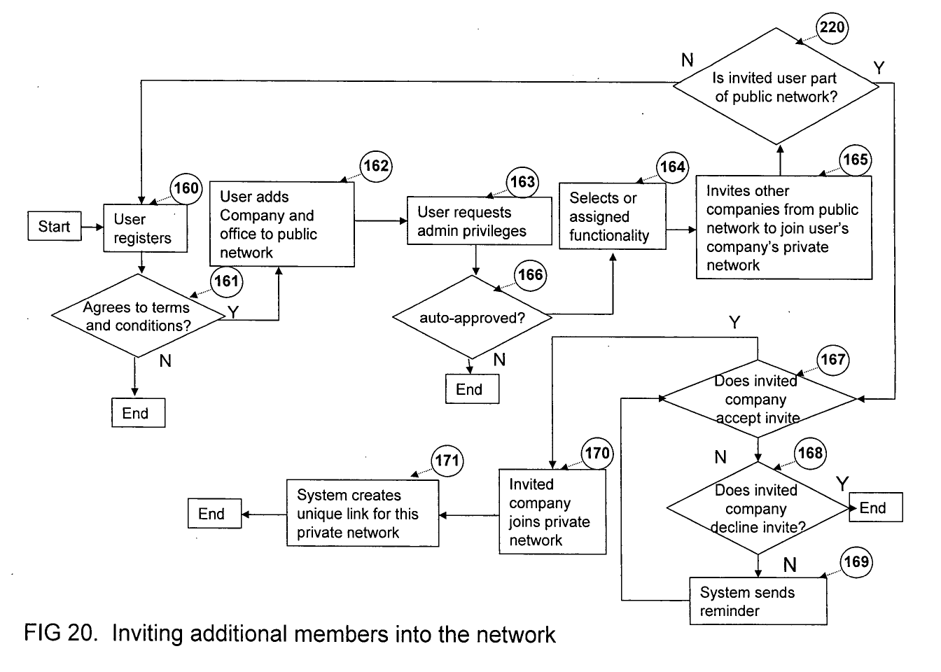

FIG. 20 illustrates one embodiment for inviting additional members into a network in accordance with the present invention. In particular, the illustrated process describes elements for growth of the public network and the private networks and the process for granting various companies and users network access. One difference between a public network and a private network is that if a user needs to get visibility into an opportunity within the private network then that user needs to be invited into that network. The functionality and role of the user within that network is defined by an administrator of the private network and the functionality and role in the public network is defined by general web site administrator. It is noted that in one embodiment, there is only one public network while there can be many private networks.

When a new user registers 160, by agreeing 161 to the network's terms and conditions the user and the company information get added 162 to a database of companies and users available on the public network. The company office location then automatically becomes available to anyone visiting the network. It is noted that the individual user's personal information, e.g., contact information or inquiries made, are available only to the people the user instructs the system to give access.

If the company is a newly registered company then the user gets privileges (e.g., either requested 163, selected 164, or auto-approved 166) to administer the company account. The system can be configured to allow certain functionality or set of functionality without restriction and require a fee that can be automatically paid through credit card for other functionalities or sets of functionalities. The system can also be configured to require network administrator authorization for the certain privileges and/or certain functionality.

Once a user and the company have been registered to the public network, he can customize his account to invite 165 certain users or groups of users and their companies to join the company's private network. The system allows for registrations from new users who have been invited in, e.g., by determining 220 whether they are new to the public network and offering them to join the private network. The process then determines 167 if the invited company accepts 167 the invite or declines 168 the invite. The system also can send 169 the user reminders at a pre-configured interval. If the invited in company and user decide 170 to join, they get privileges to the role and functionalities that they have been invited to participate and the system creates 171 a unique link for the private network. By joining a private network, a company automatically gets access to the public network and can control their privileges there.

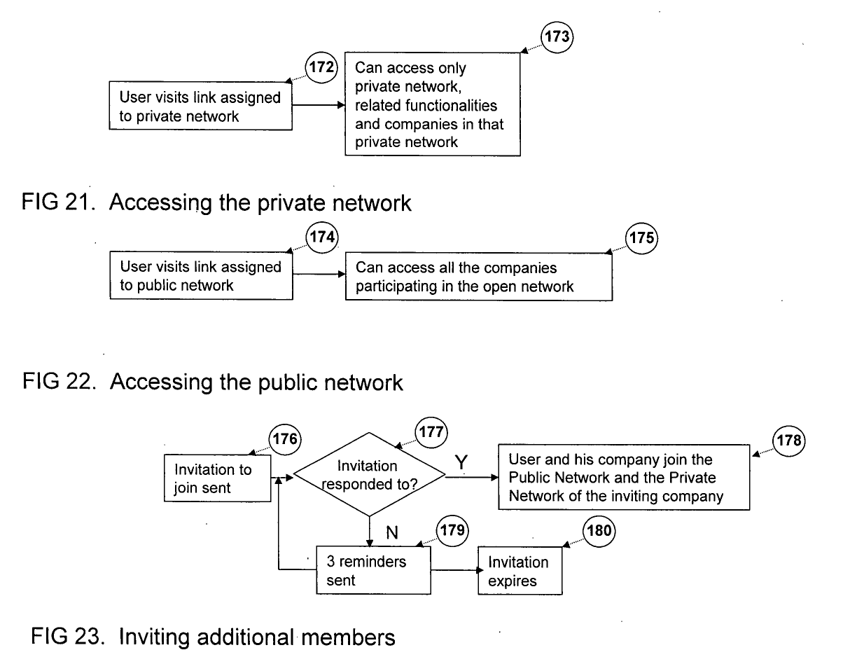

FIG. 21 illustrates one embodiment of accessing a private network in accordance with the present invention. In particular, a user can access the private network by visiting 172 (or selecting or clicking) on specific URL links. The URL link given to the network has certain parameters that indicate which network the user who is coming to and to where the system should be directed 173. Based on these parameters, the user visiting the network through that URL, will get access to either only one specific company's private network. The company operating the private network can pick and choose from a menu of options of what functionalities they want to have and get them activated instantly. For example, the system can be instructed to provide a particular company and its users access to functionalities that include the search capability on either one or on both the private network and the public network.

FIG. 22 illustrates one embodiment of accessing a public network in accordance with the present invention. In this embodiment, access to the public network may be available by visiting (or selecting or clicking) on a specific URL 174 so that access is obtained to the product data available in the public network along with access to the related inquiry processing functionalities. It is noted that the URL can be generated by the system when it is launched or started and may be part of the public network and may be configured so that a unique URL is created just for the private network. Users visiting the link assigned to the public network have access to all the companies participating in the public network and can access the individual functionalities that these companies participating in the public network have subscribed to 175.

FIG. 23 illustrates one embodiment of inviting additional members into a network in accordance with the present invention. In particular, the figure illustrates details of how a new company gets invited into the public network or the private network of a company. Upon user initiation, the system sends 176 an invitation to join one network or the other. If there is a response 177 to the invitation and it is accepted, the user and the company the appropriate private or public network of the inviting company. If there has been no response 177 to the invitation over predetermined time interval, a predetermined number of reminder, e.g., three reminders, may be sent 179 to the invited company requesting response to the invitation.

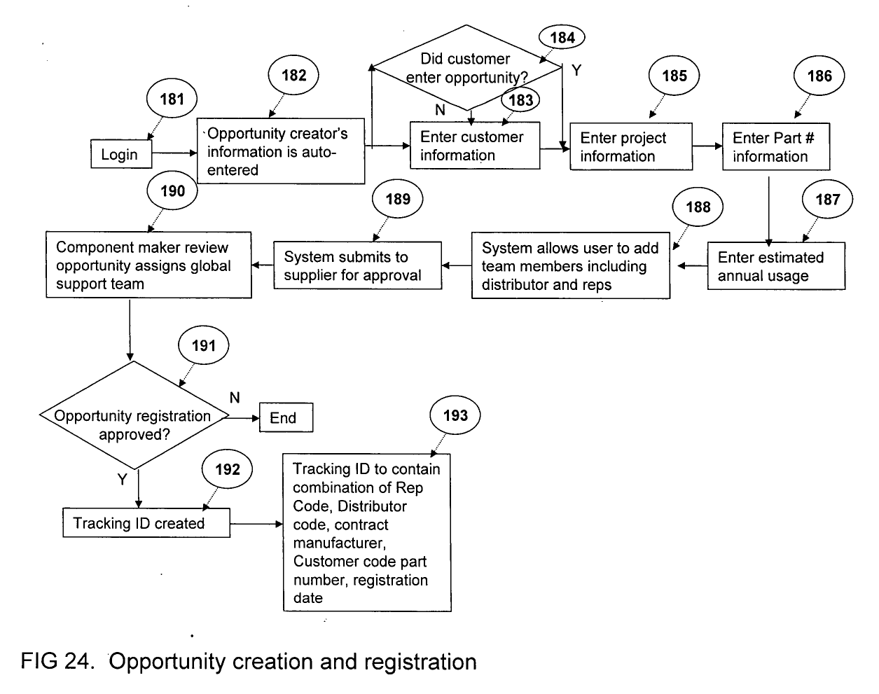

FIG. 24 illustrates one embodiment of creating and registering an opportunity in accordance with the present invention. In one embodiment, the system is configured to describes the process for registering a new opportunity into the system and how the system issues that opportunity a tracking ID. A tracking ID in the preferred embodiment of the current invention is a unique alphanumeric code associated to each opportunity. This tracking ID is a unique tracking mechanism for tracking the updates to the status on that opportunity by one of several users from different companies.

The opportunity can be created by any of the registered users after login 181. The information related to that opportunity is entered, for example, opportunity creator's information 182, customer information 183 (whether entered 184 by the customer or otherwise), project information 185, part number information 186 and estimated annual usage 187. The opportunity may be associated with an inquiry, a sample request, request for quote or an online purchase order for a small quantity purchase.

The system is also configured to allow a user to add 188 team members, including distributors and representatives. If the opportunity is input by the manufacturer's representative, it may be auto-approved or reviewed and approved by the supplier. If the opportunity is entered by a distributor or by the engineer, the manufacturer's representative may approve the opportunity and/or forward the opportunity to the supplier admin. If the opportunity is input by the system maker user, the opportunity auto-assigns the local manufacturer representative responsible for the component and the supplier may either auto-approve it or manually review and approve it 189. Once the opportunity is approved, a tracking ID is created 192. The composition of the tracking ID may identify several elements of the opportunity 193, for example, information relating to the opportunity, such as representative code, distributor code, contract manufacturer, customer code part number, and registration date.

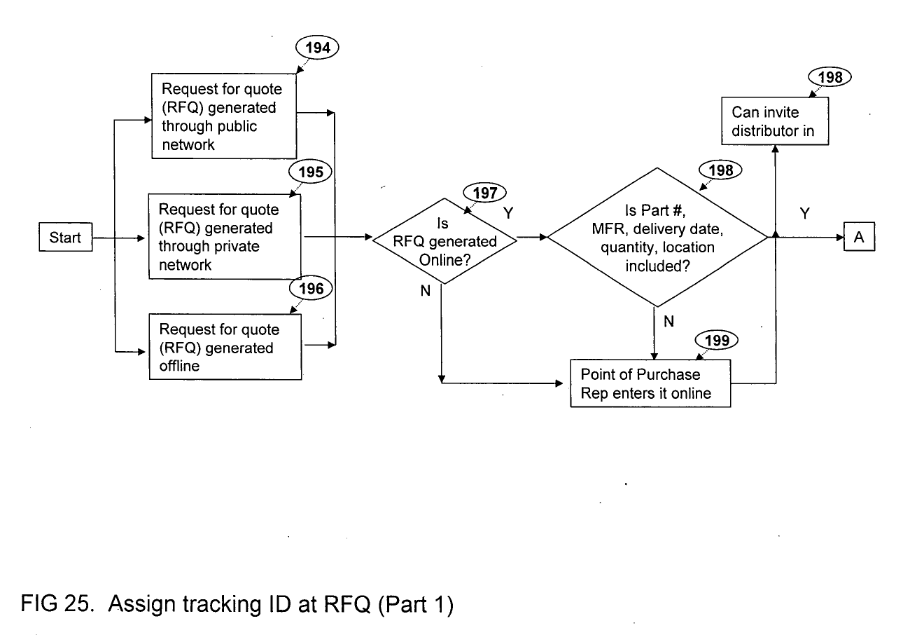

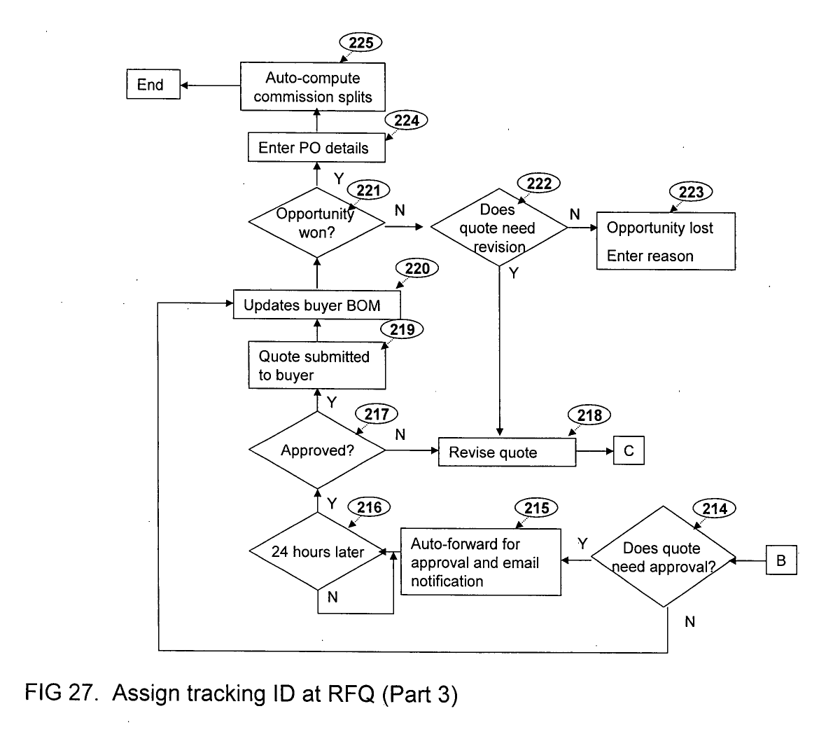

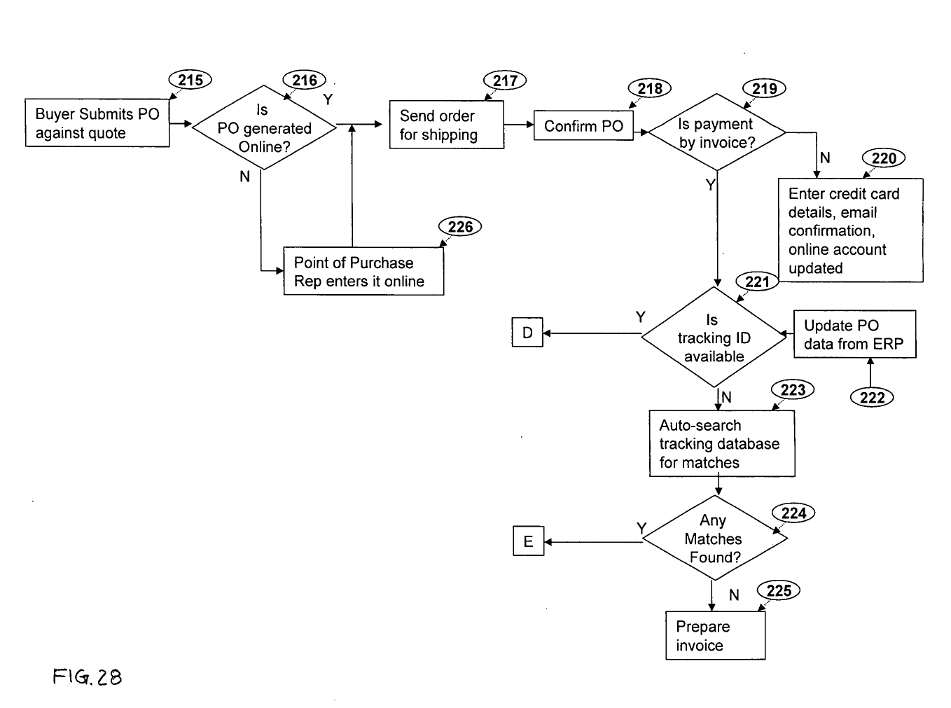

FIGS. 25, 26 and 27 illustrate one embodiment for assigning a tracking identification (ID) at a request for quotation (RFQ) in accordance with the present invention. In one embodiment a request for quote generated by a buyer and entered into the system is back tracked by the system to connect back to the tracking ID associated with the opportunity when it was first generated. This tracking mechanism assures that the representatives and distributors who were associated with the opportunity when it was at its early stages are recognized for their efforts. Further, it provides the quantitative data for evaluating the effectiveness of certain marketing and sales promotion initiatives.

In one embodiment, after an inquiry from an engineer is adequately answered or through other means the engineer is able to decide on the precise part number that engineer may need to use, the engineer seeks to get an idea of the cost of the component to include that in the decision making parameters during the design phase. This information may be provided to the engineer through a request for quote generated 194 through the public network, a request for quote generated 195 through the private network, or a request for quote generated 196 offline.

If the process determines 197 that the request for quote in generated online, the process determines 198 whether the part number, manufacturer, delivery date, and location are included. If this information is not included or the request for quote is generated offline, the point of purchase representative enters 199. In addition, other such as a distributor also may be invited to enter in data. Note that in some embodiments, when the prototype is successfully tested and moved into the production phase, the production manager or buyer attempts to get an estimate on the cost of making the product with the intention of subsequently placing a purchase order.

The system also is configured to inquire from the person entering the response for the request for quote, an opportunity tracking ID 204 if one is available. The system is configured to check that the request for quote is over a certain predetermined value 200, 202 to determine whether a new opportunity needs to be created and a tracking ID is issued 201 or an existing opportunity needs to be back tracked and assigned 206. The matches determined 207 within a database system and an opportunity is created 210 and a quote prepared 212 accordingly. In another instance, if an existing opportunity that already exists in the system has been previously selected and is being updated, this step can be skipped 204.

If the opportunity is of predetermined amount is may require a tracking ID, the manufacturer's representative is prompted to enter that information. If the tracking ID is available, it is assigned 205 to the request for quote and a quote is prepared 203. If the tracking ID is not available, the system searches 206 the database to see matches on other parameters of the opportunity. Examples of parameters include part number, design location, system maker company name or contract manufacturing company name. In particular, the process is configured to determine if there are any exact or potential matches of opportunities already registered in the database. If there is only one partial or exact match found, the system auto-assigns that tracking ID to the opportunity 209. This can subsequently be reviewed by supplier admin and unassigned, if appropriate, after manual check. If system does not find any potential matches, a new opportunity is created 210 and a tracking ID generated.

If the system determines 209 that more than one potential match to the request for quote exists, then the email messenger of the system prepares and sends emails to notify 211 the manufacturer representatives who may be potentially associated with the opportunity. The manufacturer representatives are invited to make their claim on the opportunity within a predetermined time frame, e.g., 48 hours, which the system reviews 213. If more than one manufacturer representative makes the claim, the claim is considered to be in dispute and is flagged to be settled offline when the opportunity converts into a purchase order.

In one embodiment, if the system determines that less than a predetermined number, e.g., three potential matches exist, then the system auto sends the email notifications. If more than 3 potential matches exist, then the system checks to see the “most likely 3 potential matches” based on greater number of fields that match. The ranking considers: part number, design engineer name, system maker name, manufacturing company name, design-in location and the manufacturing location in that order. The system's automatic assignment can be overwritten by the supplier to manually enter an existing tracking ID associated with the opportunity.

Subsequently the manufacturers' representative prepares the quote on the request for quote and enters it into the system 212. Depending on the quote, the manufacturer's representative forwards it or allows the system to automatically route it to the supplier for further approval or revision 214. Manufacturer's representative can also open a private message board with the supplier to exchange comments on the opportunity. Private message board is limited only to two registered users. The email messenger sends the supplier a reminder email if no response is submitted 216 within a predetermined time period, e.g., 24 hours. The requirements of what kind of quotes need supplier administrator approval can be set by the supplier administrator during initial system set-up, for example, as described with respect to FIG. 15. Once an approved quote is prepared, it is submitted through the system to the buyer 219 and the system updates the bill of materials (BOM) 220 and the email messenger sends the buyer an email alert about the submitted quote.

The quote is reviewed by the buyer who can determine 221 whether an opportunity is won by approving it, rejecting it, or requesting further clarifications or revisions. The system may be configured to communicate modifications to the quote through a private message board that is provided by the system for this interaction 222. After the predetermined time interval, e.g., 24 hours, if no response is submitted by the buyer, the email messenger in the system sends a reminder email asking the buyer to update whether a decision has been made, and if no decision has been made, when he expects to make the decision. The email messenger sends the same email reminder to the buyer asking him for an update on the date selected by the buyer.

If the quote is rejected, the opportunity is closed in the system and is forwarded to the opportunity tracking system as a lost opportunity. The manufacturer's representative is notified of this and offered the opportunity to assign 223 a reason for the same. If the opportunity is won, the buyer accepts the quotation and converts 224 it into a purchase order. The system then assigns or automatically computes 225 split commissions to the representatives associated with the opportunity based on split percentage rules set by the supplier for the system.

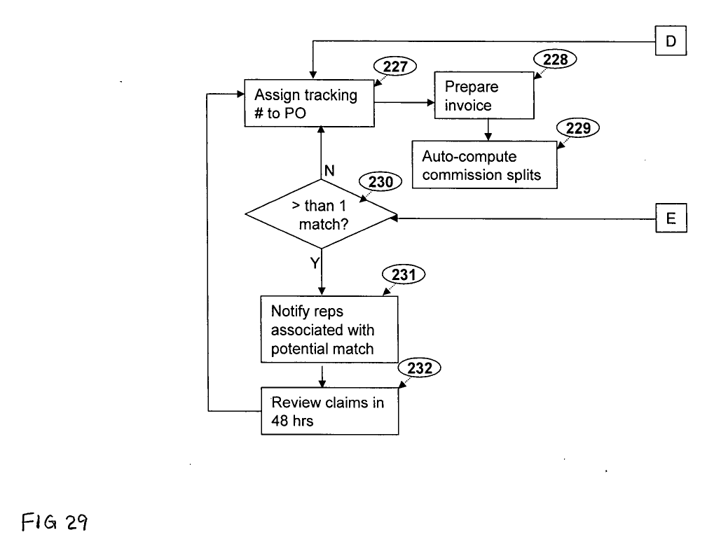

FIGS. 28 and 29 illustrate one embodiment of assigning split commissions at a purchase order in accordance with the present invention. By way of example, the process is tracked through when the buyer generates a purchase order either against a quote that was created online using the system or when the purchase order is entered from the back end enterprise resource planning (ERP) system for the supplier and is attempted to match to the opportunities on the system's networks.

In particular, once an order is received 215, the system prepares a shipment or delivery order that is sent 217 either to the warehouse or to the factory. If the order is an online credit card order, the credit card details are entered 220 to create the invoice to be send along with the shipment. If the order is submitted by mechanisms outside the system like an email or facsimile, the point of purchase manufacturer's representative enters 226 the order online. If the order is submitted through other online mechanisms, for example, Rosettanet or EDI or is in the company's existing ERP system, it is uploaded 222 into the system.

If the invoice is to be sent 219 separately, the system first determines 221 if the tracking ID is available. If the tracking number is available it is assigned to the purchase order, and the shipment processed and the invoicing completed. If the tracking ID is not available, the system does an auto-search 223 for the tracking ID and follows similar steps 230, 231 as described with FIG. 29. If the process determines 224 that no tracking ID is available, the invoice is prepared 225 for the regular price. However, if the tracking ID is available, the price on the invoice is the one associated with the opportunity for which the tracking number was assigned 228. Commission splits are subsequently computed and assigned or auto-computed 229 with respect to the representatives associated with the opportunity.

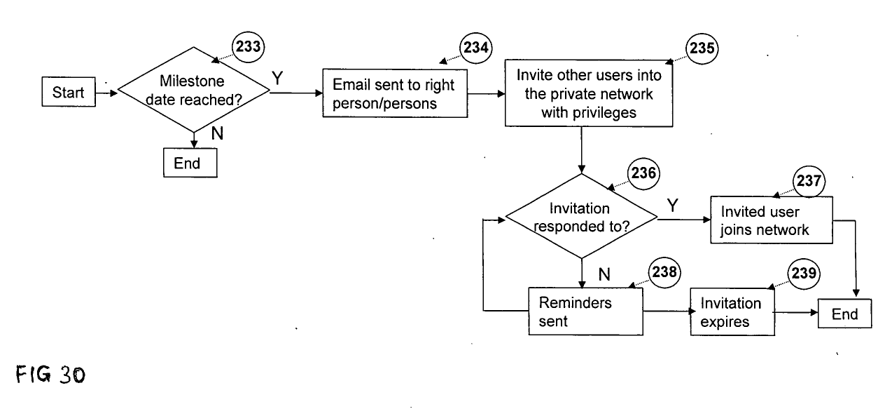

FIG. 30 illustrates one embodiment for opportunity tracking in accordance with the present invention. By way of example, when the engineer enters the sample order, he is also required to enter the evaluation end date, product date and production schedule. The dates entered into the system similar to this include but are not limited to the prototype date, the production start date. When these dates are reached, the system sends 234 out the pre-defined email to all users associated assigned in the system to receive this email on this given opportunity. For instance, at the evaluation end date the system sends and email to the engineer asking him if the component he had sampled was designed in.

Similarly, after a predetermined time frame, e.g., 30 days after the design-in date, the system sends an email to the engineer asking him for the name and email address of the program manager who can invite 235 others into the private network and manage the opportunity from the OEM side. The system captures the response and instantly creates a unique userid using on the program manager's email identifier, enters his contact information and company information and sends and email asking the program manager to select a password and create 236 the account. Once the program manager has completed this task of responding 237 to the invitation, visibility is provided into the opportunity and tasks can be updated and managed. In addition, by accepting, they automatically join the open network and the private network of the inviting users company. If the invited-in user does not join in right away, the system sends 238 a predetermined number of reminders on the subject. If the program manager or other such invited in user does not join even after these automatic follow-up and invitations expire 239 and are not sent out anymore.

The disclosure herein illustrates advantages of disclosed embodiments, for example, easy access for system engineers to current, comprehensive and reliable product information and support. It also enables these engineers to find component information they are looking for from the supplier's website and save it for future reference. This in turn accelerates the pace of innovation design and product development.

Another advantage of the disclosed embodiments is instant access to relevant information that enables members of a sales team to provide better support without spending additional time and effort. By bringing engineers to search and find product information, the system generates leads and product related inquiries for suppliers and their sales channel. It also enables the suppliers to automatically assign a global team to support the inquiries, convert them into design wins and subsequently track the global sales resulting from a single point of design. By providing a tracking mechanism it ensures that different organizations or subsidiaries of a company and third party manufacturers' representatives and distributors supporting an opportunity are recognized for their efforts and fairly compensated.

Upon reading this disclosure, those of skill in the art will appreciate still additional alternative structural and functional designs for a system and a process for searching industrial component data, building industry networks, and generating and tracking design opportunities through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for aggregating product part number, associated description, and product parameter for a plurality of products from plurality of web sites, the method comprising:
identifying a web site having information corresponding to products for a component industry; and
executing crawler to extract information from databases exposed on the web site.

2. The method of claim 1, further comprising generating an index from the extracted information based on a predefined taxonomy.

3. The method of claim 2, wherein the predefined taxonomy comprises an associated description for the plurality of products.

4. The method of claim 2, further comprising ranking the index through correlation of words in the associated description.

5. A computer readable medium structured to store instructions, the instructions for execution on a processor to perform steps comprising:
identifying a web site having information corresponding to products for a component industry; and
executing crawler to extract information from databases exposed on the web site.

6. The computer readable medium of claim 5, wherein the instructions executable on a processor to perform steps further comprise generating an index from the extracted information based on a predefined taxonomy.

7. The computer readable medium of claim 6 wherein the predefined taxonomy comprises an associated description for the plurality of products.

8. The computer readable medium of claim 5, wherein the instructions executable on a processor to perform steps further comprise ranking the index through correlation of words in the associated description.

9. A method for access to industrial information in a private network, the private network within a public network, the method comprising:
defining predefined roles for entities in the private network;
inviting the entities into the private network;
defining relationships between the invited entities in the private network based on the defined roles; and
defining a single access point to information in the private for entities in the public network based on the defined roles and defined relationship.

10. The method of claim 9, further comprising customizing a view for a user of a web site in the private network.

11. The method of claim 10, wherein customizing a view is through defining a uniform resource locator (URL) to access the information.

12. The method of claim 9, wherein an entity in the private network is given permission to invite an entity in the public network to join the private network.

13. A method for tracking sales opportunities through a sales cycle, the method comprising:
receiving input relating to a sales opportunity from a first buyer having a first role, the input comprising requirements for the sales opportunity including predefined checkpoints; and
transmitting to the first buyer a request for updated information relating to the sales opportunity, the updated information corresponding to the predefined checkpoints.

14. The method of claim 13, further comprising receiving input relating to the sales opportunity from a second buyer having a second role, the input comprising additional predefined requirements corresponding to the opportunity

15. The method of claim 13, wherein the predefined checkpoints comprises one of a milestone, user defined or date, a predefined date, or time interval.
